(19) United States
(12) Patent Application Publication
(10) Pub. No.: US 2026/0362371 A1
(43) Pub. Date: Nov. 12, 2026

(54) MEASUREMENT CONFIGURATIONS AND MEASUREMENT REPORT ENHANCEMENTS BASED ON AREA IDS

(71) Applicant: QUALCOMM Incorporated, San Diego, CA (US)

(72) Inventors: Alexandros MANOLAKOS, Athens (GR); Mukesh KUMAR, Hyderabad, CA (US); Srinivas YERRALLI, San Diego, CA (US)

(21) Appl. No.: 19/114,104

(22) PCT Filed: Nov. 14, 2023
(86) PCT No.: PCT/US2023/037238

§ 371 Date: Mar. 21, 2025

(30) Foreign Application Priority Data
Dec. 6, 2022 (GR) 20220101011

(51) Int. Cl. H04W 64/00

(52) U.S. Cl. CPC H04W 64/00

(57) ABSTRACT

Aspects presented herein relate to methods and devices for wireless communication including an apparatus, e.g., a UE or a network entity. The apparatus may obtain a request to perform a set of positioning measurements for one or more areas, where the request includes a measurement and reporting configuration for a set of area IDs associated with the one or more areas. The apparatus may also perform the set of positioning measurements based on the UE being within one area of the one or more areas associated with the set of area IDs. The apparatus may also transmit, for a network entity after the performance of the set of positioning measurements, the report of the set of positioning measurements based on the UE being within the one area of the one or more areas associated with the set of area IDs.

### CROSS-REFERENCE TO RELATED APPLICATION

This application claims the benefit of Greece Patent Application Serial No. 20220101011, entitled “MEASUREMENT CONFIGURATIONS AND MEASUREMENT REPORT ENHANCEMENTS BASED ON AREA IDS” and filed on Dec. 6, 2022, which is expressly incorporated by reference herein in its entirety.

### TECHNICAL FIELD

The present disclosure relates generally to communication systems, and more particularly, to positioning measurements in wireless communication systems.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be an apparatus for wireless communication at a user equipment (UE) (e.g., a wireless device). The apparatus may transmit, for a network entity, an indication of a UE capability for an association of a plurality of area identifiers (IDs) with a plurality of positioning methods, where the plurality of area IDs corresponds to a set of area IDs, and where the plurality of positioning methods corresponds to a set of positioning measurements. The apparatus may also obtain a request to perform a set of positioning measurements for one or more areas, where the request includes a measurement and reporting configuration for a set of area identifiers (IDs) associated with the one or more areas, where the measurement and reporting configuration includes information associated with a performance of the set of positioning measurements and a report of the set of positioning measurements. The apparatus may also receive an assistance data configuration from a network entity, where at least one first area ID in the set of area IDs is associated with the assistance data configuration. Additionally, the apparatus may perform the set of positioning measurements based on the UE being within one area of the one or more areas associated with the set of area IDs. The apparatus may also transmit, for a network entity after the performance of the set of positioning measurements, the report of the set of positioning measurements based on the UE being within the one area of the one or more areas associated with the set of area IDs.

In an aspect of the disclosure, a method, a computer-readable medium, and an apparatus are provided. The apparatus may be an apparatus for wireless communication at a network entity (e.g., a server or a location management function (LMF)). The apparatus may receive, from a UE, an indication of a UE capability for an association of a plurality of area IDs with a plurality of positioning methods, where the plurality of area IDs corresponds to a set of area IDs, and where the plurality of positioning methods corresponds to a set of positioning measurements. The apparatus may also configure a measurement and reporting configuration for a set of area identifiers (IDs) associated with one or more areas, where the measurement and reporting configuration includes information associated with a performance of a set of positioning measurements and a report of the set of positioning measurements. The apparatus may also transmit, for a user equipment (UE), a request to perform the set of positioning measurements for the one or more areas, where the request includes the measurement and reporting configuration for the set of area IDs associated with the one or more areas. Moreover, the apparatus may transmit an assistance data configuration for the UE, where at least one first area ID in the set of area IDs is associated with the assistance data configuration. The apparatus may also receive the report of the set of positioning measurements based on the UE being within one area of the one or more areas.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of a wireless communication system.

FIG. 6 is a diagram illustrating an example positioning procedure.

FIG. 7 is a diagram illustrating example regions for positioning measurements.

FIG. 8 is a diagram illustrating example regions for positioning measurements.

FIG. 9 is a communication flow diagram illustrating example communications between a UE and a network entity.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for an example apparatus and/or network entity.

FIG. 15 is a diagram illustrating an example of a hardware implementation for an example network entity.

FIG. 16 is a diagram illustrating an example of a hardware implementation for an example network entity.

### DETAILED DESCRIPTION

Some aspects of wireless communication may utilize different types of positioning reference signals (PRSs), such as downlink (DL) PRSs. PRSs are utilized by different wireless communications (e.g., new radio (NR)) and positioning methods in order to enable devices (e.g., UEs) to detect and measure different objects. For example, PRSs may enable UEs to detect and measure an increased about of neighbor transmission-reception points (TRPs) or base stations. Several different types of positioning configurations are supported in wireless communications in order to enable a variety of deployments or environments for the devices or UEs (e.g., indoor environments, outdoor environments, sub-6 environments, millimeter wave (mmW) environments). Both UE-assisted positioning methods (e.g., calculations) and UE-based position methods are supported by different types of wireless communications (e.g., NR). Further, some types of positioning methods may be supported by specific types of wireless communication (e.g., NR). For instance, NR positioning methods may support at least one of: NR multiple round trip time (multi-RTT) positioning, NR downlink (DL) time difference of arrival (DL-TDOA) positioning, or NR DL angle of departure (DL-AoD) positioning. Different aspects of positioning may also utilize preconfigured DL PRS assistance data (AD). Preconfigured DL PRS AD may refer to the DL-PRS assistance data (with associated validity criteria) that may be provided to the UE (e.g., before or during an ongoing LTE positioning protocol (LPP) positioning session), to be then utilized for potential positioning measurements at a subsequent time (e.g., for deferred mobile terminated location request (MT-LR)). In some aspects, pre-configured DL-PRS assistance data may include multiple instances, where each instance may be applicable to a different area within the network. Also, each DL-PRS assistance data instance may be associated with an area ID. In some instances, the area ID may include a list of cells where the UE may be camped on/connected. Further, an applicable area ID at the UE location may be selected based on the cell where the UE is camped on/connected. The instance of the assistance data may be valid/selected if the UE is camped on/connected to one of the cells indicated within the list of cells in the area ID. In some areas or locations, a network entity (e.g., a location management function (LMF)) may have improved information about the environment of a device (e.g., a UE) compared to other areas or locations. For instance, in one area, a reporting LOS component may be useful, whereas in other areas the LOS component reposting may not be useful. That is, a network entity (e.g., LMF) may have better information about a UE environment in one area compared to another area. For example, reporting a certain component (e.g., a LOS component) may be useful in one area, but not in another area. Aspects of the present disclosure may configure or adjust the reporting conditions for a device based on a number of factors. In some instances, aspects presented herein may configure or adjust the reporting conditions for a device based on a corresponding cell or area of the device. For example, aspects presented herein may allow a network entity (e.g., LMF) to configure different report conditions for a device (e.g., UE). That is, aspects presented herein may a provide a network entity (e.g., LMF) the ability to configure different report conditions for a device (e.g., UE) based on a corresponding area ID or positioning measurement IE. In some instances, aspects presented herein may configure a number of different information elements (IEs), fields, and/or parameters in order to improve the reporting conditions for a device. Aspects of the present disclosure may allow a network entity to configure a number of different IEs, fields, and/or parameters for reporting positioning measurements and/or device environment information in order to improve the reporting conditions for a device. For instance, the network entity (e.g., LMF) may configure the device (e.g., UE) to report improved information about the environment of the device no matter the corresponding area of the device. In turn, this may allow the device (e.g., UE) to report improved information to the network entity (e.g., LMF) about the UE environment regardless of the corresponding area of the device (e.g., UE).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

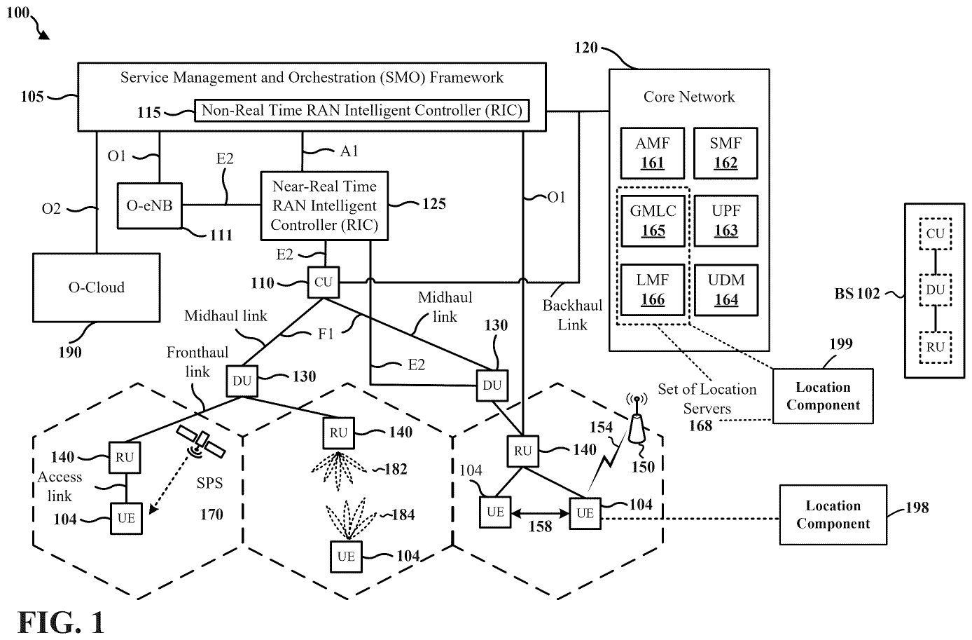

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and a velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network. In some scenarios, the term UE may also apply to one or more companion devices such as in a device constellation arrangement. One or more of these devices may collectively access the network and/or individually access the network. A network node can be implemented as a base station (i.e., an aggregated base station), as a disaggregated base station, an integrated access and backhaul (IAB) node, a relay node, a sidelink node, etc. A network entity can be implemented as a base station (i.e., an aggregated base station), or alternatively, as a central unit (CU), a distributed unit (DU), a radio unit (RU), a Near-Real Time (Near-RT) RAN Intelligent Controller (RIC), or a Non-Real Time (Non-RT) RIC in a disaggregated base station architecture.

Referring again to FIG. 1, in certain aspects, the UE 104 may include a location component 198 that may be configured to transmit, for a network entity, an indication of a UE capability for an association of a plurality of area identifiers (IDs) with a plurality of positioning methods, where the plurality of area IDs corresponds to a set of area IDs, and where the plurality of positioning methods corresponds to a set of positioning measurements. Location component 198 may also be configured to obtain a request to perform a set of positioning measurements for one or more areas, where the request includes a measurement and reporting configuration for a set of area identifiers (IDs) associated with the one or more areas, where the measurement and reporting configuration includes information associated with a performance of the set of positioning measurements and a report of the set of positioning measurements. Location component 198 may also be configured to receive an assistance data configuration from a network entity, where at least one first area ID in the set of area IDs is associated with the assistance data configuration. Location component 198 may also be configured to perform the set of positioning measurements based on the UE being within one area of the one or more areas associated with the set of area IDs. Location component 198 may also be configured to transmit, for a network entity after the performance of the set of positioning measurements, the report of the set of positioning measurements based on the UE being within the one area of the one or more areas associated with the set of area IDs.

In certain aspects, the LMF 166 and/or the set of locations servers 168 may include a location component 199 that may be configured to receive, from a UE, an indication of a UE capability for an association of a plurality of area IDs with a plurality of positioning methods, where the plurality of area IDs corresponds to a set of area IDs, and where the plurality of positioning methods corresponds to a set of positioning measurements. Location component 199 may also be configured to configure a measurement and reporting configuration for a set of area identifiers (IDs) associated with one or more areas, where the measurement and reporting configuration includes information associated with a performance of a set of positioning measurements and a report of the set of positioning measurements. Location component 199 may also be configured to transmit, for a user equipment (UE), a request to perform the set of positioning measurements for the one or more areas, where the request includes the measurement and reporting configuration for the set of area IDs associated with the one or more areas. Location component 199 may also be configured to transmit an assistance data configuration for the UE, where at least one first area ID in the set of area IDs is associated with the assistance data configuration. Location component 199 may also be configured to receive the report of the set of positioning measurements based on the UE being within one area of the one or more areas. Although the following description may be focused on 5G NR, the concepts described herein may be applicable to other similar areas, such as LTE, LTE-A, CDMA, GSM, and other wireless technologies.

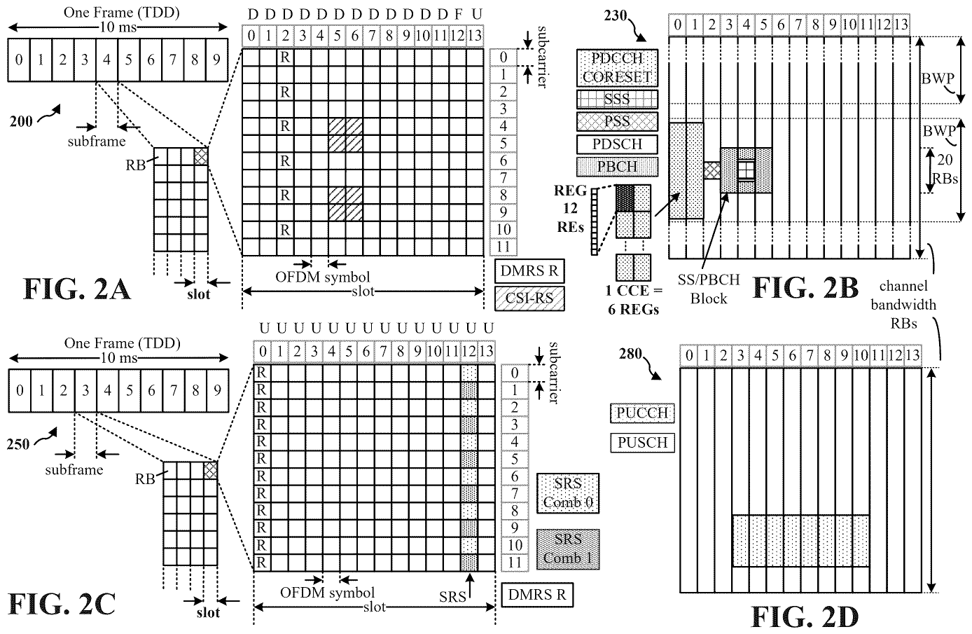

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

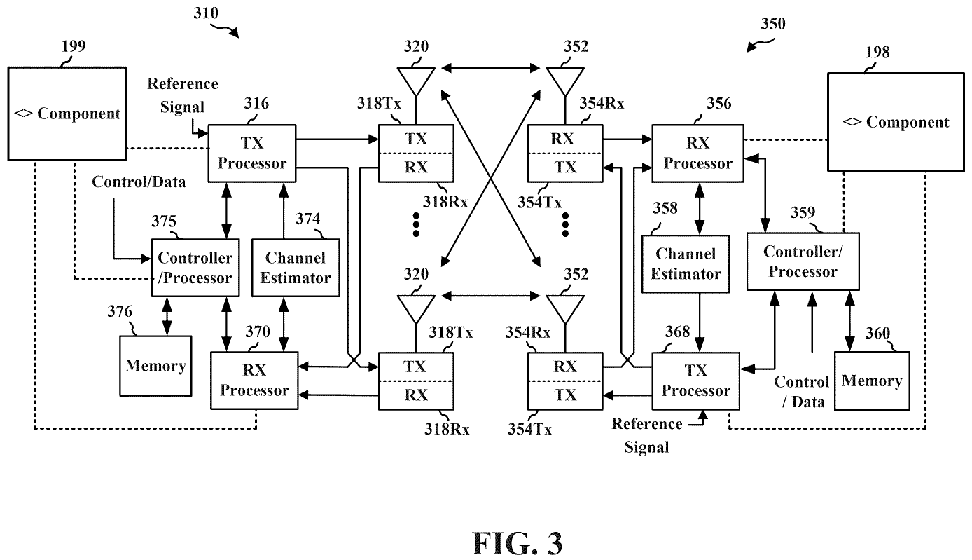

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality. The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the location component 198 of FIG. 1. At least one of the TX processor 316, the RX processor 370, and the controller/processor 375 may be configured to perform aspects in connection with the location component 199 of FIG. 1.

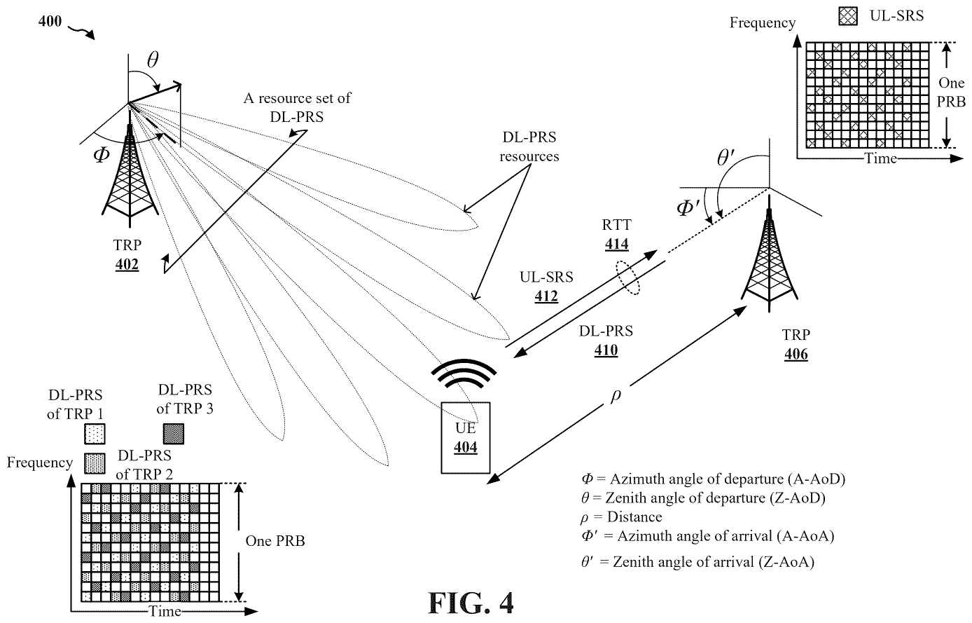

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and DL-PRS-RSRP of the received signals) using assistance data received from the positioning server, and the TRPs 402, 406 measure the gNB Rx-Tx time difference measurements (and UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406. DL-TDOA positioning may make use of the DL reference signal time difference (RSTD) (and DL-PRS-RSRP) of downlink signals received from multiple TRPs 402, 406 at the UE 404. The UE 404 measures the DL RSTD (and DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and UL-SRS-RSRP) at multiple TRPs 402, 406 of uplink signals transmitted from UE 404. The TRPs 402, 406 measure the UL-RTOA (and UL-SRS-RSRP) of the received signals using assistance data received from the positioning server, and the resulting measurements are used along with other configuration information to estimate the location of the UE 404. UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine to and/or to enhance certainty, to supplement/complement measurements, and/or to substitute/provide for missing information.

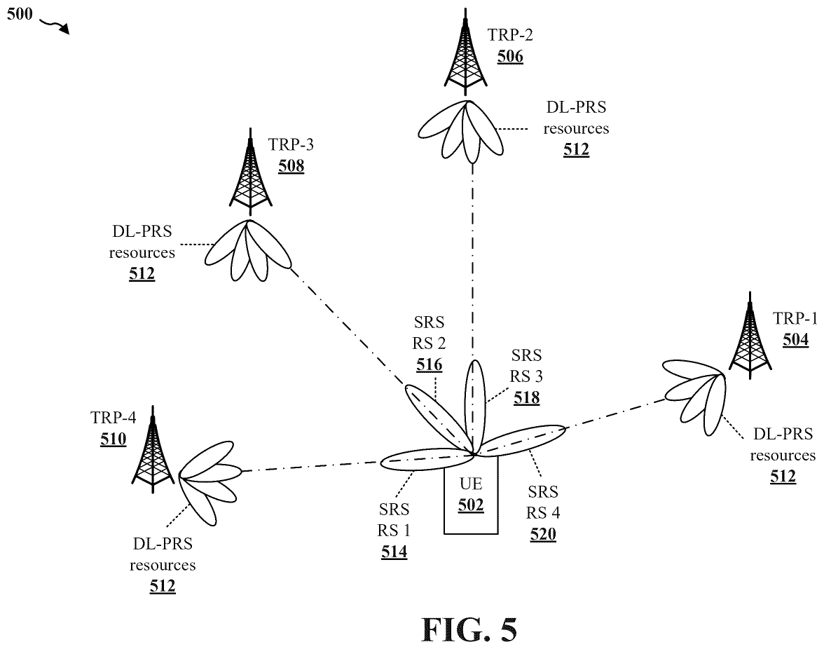

FIG. 5 is a diagram 500 illustrating an example of estimating a position of a UE based on multi-RTT measurements from multiple TRPs in accordance with various aspects of the present disclosure. A UE 502 may be configured by a serving base station to decode DL-PRS resources 512 that correspond to and are transmitted from a first TRP 504 (TRP-1), a second TRP 506 (TRP-2), a third TRP 508 (TRP-3), and a fourth TRP 510 (TRP-4). The UE 502 may also be configured to transmit UL-SRSs on a set of UL-SRS resources, which may include a first SRS resource 514, a second SRS resource 516, a third SRS resource 518, and a fourth SRS resource 520, such that the serving cell(s), e.g., the first TRP 504, the second TRP 506, the third TRP 508, and the fourth TRP 510, and as well as other neighbor cell(s), may be able to measure the set of the UL-SRS resources transmitted from the UE 502. For multi-RTT measurements based on DL-PRS and UL-SRS, as there may be an association between a measurement of a UE for the DL-PRS and a measurement of a TRP for the UL-SRS, the smaller the gap is between the DL-PRS measurement of the UE and the UL-SRS transmission of the UE, the better the accuracy may be for estimating the position of the UE and/or the distance of the UE with respect to each TRP.

In some aspects of wireless communication, the terms “positioning reference signal” and “PRS” may generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. In some aspects, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

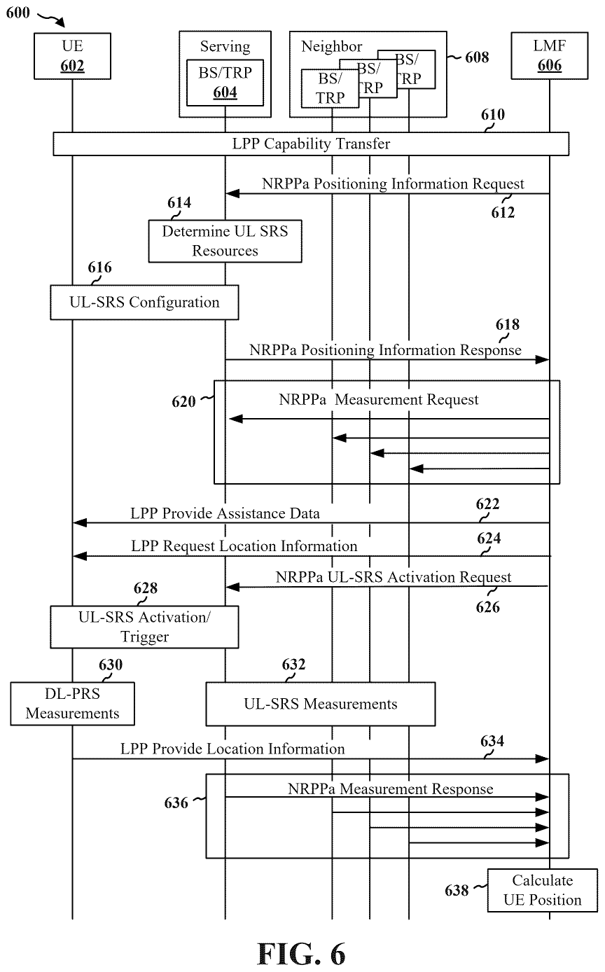

FIG. 6 is a communication flow 600 illustrating an example multi-RTT positioning procedure in accordance with various aspects of the present disclosure. The numberings associated with the communication flow 600 do not specify a particular temporal order and are merely used as references for the communication flow 600. In addition, a DL-only and/or an UL-only positioning may use a subset or subsets of this multi-RTT positioning procedure.

At 610, an LMF 606 may request one or more positioning capabilities from a UE 602 (e.g., from a target device). In some examples, the request for the one or more positioning capabilities from the UE 602 may be associated with an LTE Positioning Protocol (LPP). For example, the LMF 606 may request the positioning capabilities of the UE 602 using an LPP capability transfer procedure. At 612, the LMF 606 may request UL SRS configuration information for the UE 602. The LMF 606 may also provide assistance data specified by a serving base station 604 (e.g., pathloss reference, spatial relation, and/or SSB configuration(s), etc.). For example, the LMF 606 may send an NR Positioning Protocol A (NRPPa) positioning information request message to the serving base station 604 to request UL information for the UE 602.

At 614, the serving base station 604 may determine resources available for UL SRS, and at 616, the serving base station 604 may configure the UE 602 with one or more UL SRS resource sets based on the available resources. At 618, the serving base station 604 may provide UL SRS configuration information to the LMF 606, such as via an NRPPa positioning information response message. At 620, the LMF 606 may select one or more candidate neighbor BSs/TRPs 608, and the LMF 606 may provide an UL SRS configuration to the one or more candidate neighbor BSs/TRPs 608 and/or the serving base station 604, such as via an NRPPa measurement request message. The message may include information for enabling the one or more candidate neighbor BSs/TRPs 608 and/or the serving base station to perform the UL measurements.

At 622, the LMF 606 may send an LPP provide assistance data message to the UE 602. The message may include specified assistance data for the UE 602 to perform the DL measurements. At 624, the LMF 606 may send an LPP request location information message to the UE 602 to request multi-RTT measurements. At 626, for semi-persistent or aperiodic UL SRS, the LMF 606 may request the serving base station 604 to activate/trigger the UL SRS in the UE 602. For example, the LMF 606 may request activation of UE SRS transmission by sending an NRPPa positioning activation request message to the serving base station 604.

At 628, the serving base station 604 may activate the UE SRS transmission and send an NRPPa positioning activation response message. In response, the UE 602 may begin the UL-SRS transmission according to the time domain behavior of UL SRS resource configuration. At 630, the UE 602 may perform the DL measurements from the one or more candidate neighbor BSs/TRPs 608 and/or the serving base station 604 provided in the assistance data. At 632, each of the configured one or more candidate neighbor BSs/TRPs 608 and/or the serving base station 604 may perform the UL measurements. At 634, the UE 602 may report the DL measurements to the LMF 606, such as via an LPP provide location information message. At 636, each of the one or more candidate neighbor BSs/TRPs 608 and/or the serving base station 604 may report the UL measurements to the LMF 606, such as via an NRPPa measurement response message. At 638, the LMF 606 may determine the RTTs from the UE 602 and BS/TRP Rx-Tx time difference measurements for each of the one or more candidate neighbor BSs/TRPs 608 and/or the serving base station 604 for which corresponding UL and DL measurements were provided at 634 and 636, and the LMF 606 may calculate the position of the UE 602.

Some aspects of wireless communication may utilize different types of positioning reference signals (PRSs), such as downlink (DL) PRSs. PRSs are utilized by different wireless communications (e.g., new radio (NR)) and positioning methods in order to enable devices (e.g., UEs) to detect and measure different objects. For example, PRSs may enable UEs to detect and measure an increased about of neighbor TRPs or base stations. Several different types of positioning configurations are supported in wireless communications in order to enable a variety of deployments or environments for the devices or UEs (e.g., indoor environments, outdoor environments, sub-6 environments, mmW environments). Both UE-assisted positioning methods (e.g., calculations) and UE-based position methods are supported by different types of wireless communications (e.g., NR). Further, some types of positioning methods may be supported by specific types of wireless communication (e.g., NR). For instance, NR positioning methods may support at least one of: NR multiple round trip time (multi-RTT) positioning, NR downlink (DL) time difference of arrival (DL-TDOA) positioning, or NR DL angle of departure (DL-AoD) positioning.

In some aspects, different types of reference signals (e.g., DL or uplink (UL) reference signals) and UE measurements may be utilized to facilitate the support of different positioning techniques. For example, DL PRSs and DL reference signal time difference (RSTD) UE measurements may facilitate support of DL-TDOA positioning. Also, DL PRSs and DL PRS reference signal received power (RSRP) UE measurements may facilitate support of DL-TDOA positioning, DL-AoD positioning, and/or multi-RTT positioning. Moreover, DL PRSs and sounding reference signals (SRS) for positioning and UE reception (Rx)-transmission (Tx) time different UE measurements may facilitate support of multi-RTT positioning. Further, synchronization signal blocks (SSBs) and channel state information (CSI)-reference signals (CSI-RSs) for radio resource management (RRM), as well as synchronization signal (SS)-RSRP (e.g., RSRP for RRM), SS-reference signal received quality (SS-RSRQ) (e.g., for RRM), CSI-RSRP (e.g., for RRM), and CSI-RSRP (e.g., for RRM), may facilitate support of enhanced-cell identifier (ID) (E-CID) positioning.

Different aspects of positioning may also utilize preconfigured DL PRS assistance data (AD). Preconfigured DL PRS AD may refer to the DL-PRS assistance data (with associated validity criteria) that may be provided to the UE (e.g., before or during an ongoing LTE positioning protocol (LPP) positioning session), to be then utilized for potential positioning measurements at a subsequent time (e.g., for deferred mobile terminated location request (MT-LR)). In some aspects, pre-configured DL-PRS assistance data may include multiple instances, where each instance may be applicable to a different area within the network. Also, each DL-PRS assistance data instance may be associated with an area ID. In some instances, the area ID may include a list of cells where the UE may be camped on/connected. Further, an applicable area ID at the UE location may be selected based on the cell where the UE is camped on/connected. The instance of the assistance data may be valid/selected if the UE is camped on/connected to one of the cells indicated within the list of cells in the area ID.

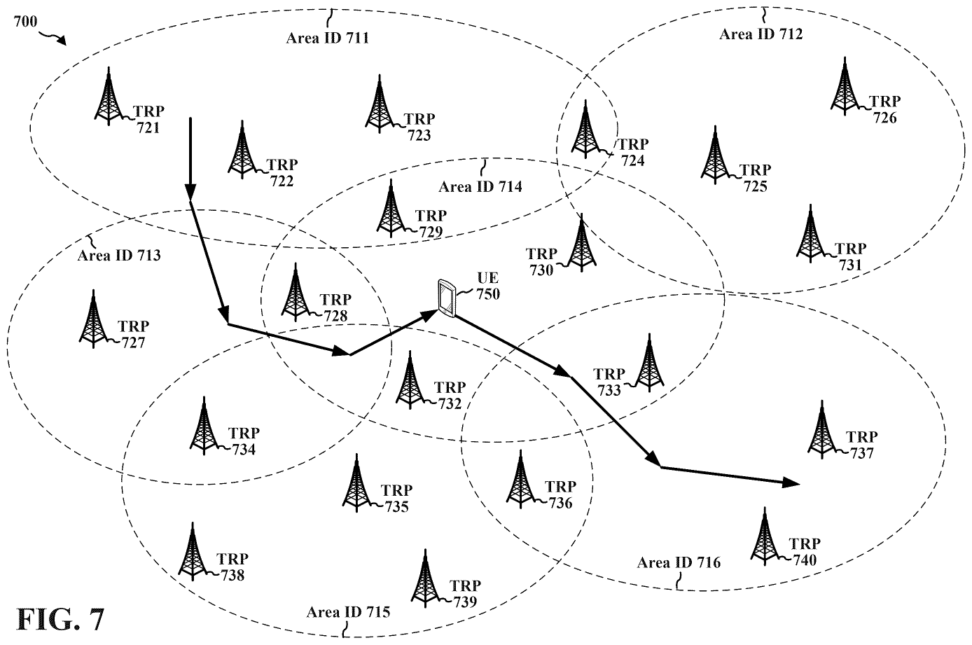

FIG. 7 is a diagram 700 illustrating example regions for positioning measurements. More specifically, FIG. 7 depicts a region for positioning measurements including a number of cells associated with an area identifier (ID). As shown in FIG. 7, diagram 700 includes a number of cells (i.e., the dashed-line ellipses in FIG. 7) and associated area IDs (e.g., area ID 711, area ID 712, area ID 713, area ID 714, area ID 715, and area ID 716). Diagram 700 also depicts a number of transmission-reception points (TRPs) within the areas (e.g., TRP 721, TRP 722, TRP 723, TRP 724, TRP 725, TRP 726, TRP 727, TRP 728, TRP 729, TRP 730, TRP 731, TRP 732, TRP 733, TRP 734, TRP 735, TRP 736, TRP 737, TRP 738, TRP 739, and TRP 740), as well as UE 750. As shown by the arrows in FIG. 7, UE 750 is gradually moving through the different cells and associated area IDs. That is, UE 750 starts in the cell corresponding to area ID 711, then moves to the cell corresponding to area ID 713, then moves to the cell corresponding to area ID 715, then moves to the cell corresponding to area ID 714, and then moves to the cell corresponding to area ID 716. The movement of UE 750 corresponds to the cell on which the UE 750 is camped on or connected. As indicated above, each of the area IDs in FIG. 7 may be associated with a DL-PRS assistance data instance for pre-configured DL-PRS assistance data.

In some aspects, different types of parameters or information elements (IEs) may be used to request different positioning measurements or location measurements. For example, a DL-AoD location information request IE or field (NR-DL-AoD-RequestLocationInformation) may be used by a location server or LMF in order to request DL-AoD location measurements from a target device (e.g., a UE). There may be a number of DL-AoD location information request IEs, fields, or parameters. For instance, an NR assistance availability IE or field (nr-AssistanceAvailability) may indicate whether a target device may request additional PRS assistance data from the server (e.g., TRUE may mean allowed and FALSE may mean not allowed). Also, a maximum DL-PRS RSRP measurement per transmission-reception point (TRP) IE or field (maxDL-PRS-RSRP-MeasurementsPerTRP) may specify a maximum number of DL-PRS RSRP measurements on different DL-PRS resources from a same TRP. Further, a first path-RSRP measurement request IE or field (firstPathRSRP-MeasurementReq) may indicate that the target device is requested to measure the PRS RSRP of a first path. Moreover, a line-of-sight (LOS) or non-LOS (NLOS) indicator request IE or field (nr-los-nlos-IndicatorRequest) may indicate that the target device is requested to provide the indicated type and granularity of the estimated LOS-NLOS-indicator in the NR-DL-AoD-SignalMeasurementInformation field or IE. In addition, a requested downlink PRS processing sample IE or field (requestedDL-PRS-ProcessingSamples) may indicate the requested number of DL-PRS processing samples. Also, the enumerated value ‘ml’ may indicate 1-sample DL-PRS processing is requested.

Additionally, a DL-TDOA location information request IE or field (NR-DL-TDOA-RequestLocationInformation) may be used by a location server or LMF in order to request DL-TDOA location measurements from a target device (e.g., a UE). There may be a number of DL-TDOA location information request IEs, fields, or parameters. For instance, a DL PRS reference signal time difference (RSTD) measurement information request IE or field (nr-DL-PRS-RstdMeasurementInfoRequest) may indicate whether the target device is requested to report DL-PRS resource ID(s) or DL-PRS resource set ID(s) used for determining the timing of each TRP in RSTD measurements. Also, a requested measurement IE or field (nr-RequestedMeasurements) may specify the NR DL-TDOA measurements requested, which may be represented by a bit string (e.g., a one value at the bit position means the particular measurement is requested, and a zero value means not requested). An assistance availability IE or field (nr-AssistanceAvailability) may indicate whether the target device may request additional PRS assistance data from the server (e.g., TRUE means allowed and FALSE means not allowed). Further, an additional path IE or field (additionalPaths) may indicate that the target device is requested to provide the nr-AdditionalPathList in the IE NR-DL-TDOA-SignalMeasurementInformation (e.g., if this field is present, the field additionalPathsExt may be absent). A UE reception (Rx) timing error group (TEG) request IE or field (nr-UE-RxTEG-Request) may indicate that the target device is requested to provide the nr-UE-Rx-TEG-ID in the IE NR-DL-TDOA-SignalMeasurementInformation. A line-of-sight (LOS) or non-LOS (NLOS) indicator request IE or field (nr-los-nlos-IndicatorRequest) may indicate that the target device is requested to provide the indicated type and granularity of the estimated LOS-NLOS-Indicator in the NR-DL-TDOA-SignalMeasurementInformation. An additional path extension IE or field (additionalPathsExt) may indicate that the target device is requested to provide the nr-AdditionalPathListExt in the IE NR-DL-TDOA-SignalMeasurementInformation (e.g., if this field is present, the field additionalPaths may be absent). An additional path downlink PRS RSRP request IE or field (additionalPathsDL-PRS-RSRP-Request) may indicate that the target device is requested to provide the nr-DL-PRS-RSRPP for the additional paths in the IE NR-AdditionalPathList. A multiple measurement in a same report IE or field (multiMeasInSame Report) may indicate that the target device is requested to provide multiple measurement instances in a single measurement report (i.e., include the nr-DL-TDOA-SignalMeasurementInstances (in the case UE-assisted mode is requested) or nr-DL-TDOA-LocationInformationInstances (in the case UE-based mode is requested) in the IE NR-DL-TDOA-ProvideLocationInformation. A downlink PRS RSTD measurement per TRP pair IE or field (maxDL-PRS-RSTD-MeasurementsPerTRPPair) may specify the maximum number of DL-PRS RSTD measurements per pair of TRPs (e.g., the maximum number may be defined across all positioning frequency layers). A timing reporting granularity factor IE or field (timingReportingGranularityFactor) may specify a recommended reporting granularity for the DL RSTD measurements (e.g., the value (0 . . . 5) may correspond to (k0 . . . k5)) used for nr-RSTD and nr-RSTD-ResultDiff in NR-DL-TDOA-MeasElement. In some aspects, the UE may select a different granularity value for nr-RSTD and nr-RSTD-ResultDiff. A measure same downlink PRS resource with different reception (Rx) timing error group (TEG) IE or field (measureSameDL-PRS-ResourceWithDifferentRxTEGs) may indicate that a target device is requested to measure the same DL-PRS resource of a TRP with N different UE Rx TEGs. An enumerated value ‘n0’ may indicate that the number N of different UE Rx TEGs to measure the same DL PRS resource may be determined by the target device, value ‘n2’ may indicate that the target device is requested to measure the same DL-PRS resource of a TRP with 2 different UE Rx TEGs, value ‘n3’ may indicate that the target device is requested to measure the same DL-PRS resource of a TRP with 3 different UE Rx TEGs, etc. (e.g., if this field is present, the field nr-UE-TxTEG-Request may also be present). A requested downlink PRS processing sample IE or field (reducedDL-PRS-ProcessingSamples) may indicate (if set to ‘requested’) that the target device is requested to perform the requested measurements with reduced number of samples (e.g., M=1 or M=2). Also, a lower Rx beam sweeping factor IE or field (lowerRxBeamSweepingFactor-FR2) may indicate that the target device is requested to use a lower Rx beam sweeping factor than 8 for frequency range 2 (FR2) according to a UE's capability.

Moreover, a multi-RTT location information request IE or field (NR-Multi-RTT-RequestLocationInformation) may be used by a location server or LMF in order to request multi-RTT location measurements from a target device (e.g., a UE). There may be a number of multi-RTT location information request IEs, fields, or parameters. For instance, a UE Rx-Tx time difference measurement information request IE or field (nr-UE-RxTxTimeDiffMeasurementInfoRequest) may indicate that a target device is requested to report the DL-PRS resource ID(s) or DL-PRS resource set ID(s) associated with the DL-PRS resources(s) or the DL-PRS resource set(s) which are used in determining the UE Rx-Tx time difference measurements. An assistance availability IE or field (nr-AssistanceAvailability) may indicate whether a target device may request additional PRS assistance data from the server (e.g., TRUE means allowed and FALSE means not allowed). A maximum DL PRS Rx-Tx time different measurement per TRP IE or field (maxDL-PRS-RxTxTimeDiffMeasPerTRP) may specify a maximum number of UE Rx-Tx time difference measurements for different DL-PRS resources or DL-PRS resource sets per TRP. A timing reporting granularity factor IE or field (timingReportingGranularityFactor) may specify the recommended reporting granularity for the UE Rx-Tx time difference measurements (e.g., the value (0 . . . 5) may correspond to (k0 . . . k5)) used for nr-UE-RxTxTimeDiff and nr-UE-RxTxTimeDiffAdditional in NR-Multi-RTT-MeasElement. Also, the UE may select a different granularity value for nr-UE-RxTxTimeDiff and nr-UE-RxTxTimeDiffAdditional. An additional paths IE or field (additionalPaths) may indicate that the target device is requested to provide the nr-AdditionalPathList in the IE NR-Multi-RTT-SignalMeasurementInformation (e.g., if this field is present, the field additionalPathsExt may be absent). A UE reception (Rx)-transmission (Tx) timing error group (TEG) request IE or field (nr-UE-RxTxTEG-Request) may indicate that a target device is requested to provide the NR-UE-RxTx-TEG-Info in the IE NR-Multi-RTT-SignalMeasurementInformation. Here, the enumerated value ‘case1’ may indicate that a target device is requested to provide the case I choice in NR-UE-RxTx-TEG-Info, enumerated value ‘case2’ may indicate that the target device is requested to provide the case2 choice in NR-UE-RxTx-TEG-Info, etc. A measure same downlink PRS resource with different Rx-Tx TEG IE or field (measureSameDL-PRS-Resource WithDifferentRxTxTEGs) may indicate that a target device is requested to measure the same DL-PRS resource of a TRP with N different UE RxTx TEGs and with the same UE Tx TEG. Here, an enumerated value ‘n0’ may indicate that the number N of different UE RxTx TEGs to measure the same DL PRS resource may be determined by the target device, a value ‘n2’ may indicate that the target device is requested to measure the same DL-PRS resource of a TRP with 2 different UE RxTx TEGs, a value ‘n3’ may indicate that the target device is requested to measure the same DL-PRS resource of a TRP with 3 different UE RxTx TEGs, etc. (e.g., if this field is present, the field nr-UE-RxTxTEG-Request may also be present and/or the field measureSameDL-PRS-Resource WithDifferentRxTEGs may not be present). A measure same downlink PRS resource with different Rx TEG IE or field (measureSame DL-PRS-ResourceWithDifferentRxTEGs) may indicate that a target device is requested to measure the same DL-PRS resource of a TRP with N different UE Rx TEGs. Here, enumerated value ‘n0’ may indicate that the number N of different UE Rx TEGs to measure the same DL PRS resource may be determined by the target device, the value ‘n2’ may indicate that the target device is requested to measure the same DL-PRS resource of a TRP with 2 different UE Rx TEGs, the value ‘n3’ may indicate that the target device is requested to measure the same DL-PRS resource of a TRP with 3 different UE Rx TEGs, etc. (e.g., if this field is present, the field nr-UE-RxTxTEG-Request may also be present and/or the field measureSameDL-PRS-ResourceWithDifferentRxTxTEGs may not be present). A requested or reduced downlink PRS processing sample IE or field (reducedDL-PRS-ProcessingSamples or requestedDL-PRS-ProcessingSamples), if present and set to ‘requested’, may indicate that a target device is requested to perform the requested measurements with a reduced number of samples (e.g., M=1 or M=2). A line-of-sight (LOS) or non-LOS (NLOS) indicator request IE or field (nr-los-nlos-IndicatorRequest) may indicate that a target device is requested to provide the indicated type and granularity of the estimated LOS-NLOS-Indicator in the NR-Multi-RTT-SignalMeasurementInformation. An additional path extension IE or field (additionalPathsExt) may indicate that the target device is requested to provide the nr-AdditionalPathListExt in the IE NR-Multi-RTT-SignalMeasurementInformation (e.g., if this field is present, the field additionalPaths may be absent). An additional path downlink PRS RSRP request IE or field (additionalPathsDL-PRS-RSRP-Request) may indicate that a target device is requested to provide the nr-DL-PRS-RSRP for the additional paths in the IE NR-AdditionalPathList. A multiple measurement in same report IE or field (multiMeasInSameReport) may indicate that a target device is requested to provide multiple measurement instances in a single measurement report (e.g., include the nr-Multi-RTT-SignalMeasurementInstances in the IE NR-Multi-RTT-ProvideLocationInformation). Also, a lower Rx beam sweeping factor IE or field (lowerRxBeamSweepingFactor-FR2) may indicate that a target device is requested to use a lower Rx beam sweeping factor than 8 for FR2 according to a UE's capability.

In some areas or locations, a network entity (e.g., a location management function (LMF)) may have improved information about the environment of a device (e.g., a UE) compared to other areas or locations. For instance, in one area, a reporting LOS component may be useful, whereas in other areas the LOS component reposting may not be useful. That is, a network entity (e.g., LMF) may have better information about a UE environment in one area compared to another area. For example, reporting a certain component (e.g., a LOS component) may be useful in one area, but not in another area. Based on the above, it may be beneficial to configure or adjust the reporting conditions for a device based on a number of factors. For instance, it may be beneficial to adjust the reporting conditions for a device based on a corresponding cell or area of the device.

Aspects of the present disclosure may configure or adjust the reporting conditions for a device based on a number of factors. In some instances, aspects presented herein may configure or adjust the reporting conditions for a device based on a corresponding cell or area of the device. For example, aspects presented herein may allow a network entity (e.g., LMF) to configure different report conditions for a device (e.g., UE). That is, aspects presented herein may a provide a network entity (e.g., LMF) the ability to configure different report conditions for a device (e.g., UE) based on a corresponding area ID or positioning measurement IE. In some instances, aspects presented herein may configure a number of different information elements (IEs), fields, and/or parameters in order to improve the reporting conditions for a device. Aspects of the present disclosure may allow a network entity to configure a number of different IEs, fields, and/or parameters for reporting positioning measurements and/or device environment information in order to improve the reporting conditions for a device. For instance, the network entity (e.g., LMF) may configure the device (e.g., UE) to report improved information about the environment of the device no matter the corresponding area of the device. In turn, this may allow the device (e.g., UE) to report improved information to the network entity (e.g., LMF) about the UE environment regardless of the corresponding area of the device (e.g., UE).

Aspects presented herein may utilize positioning measurement reporting based on a corresponding cell/area or area ID of a device. For example, aspects presented herein may allow network entities (e.g., LMFs) to configure area ID-based positioning measurement IE reporting for a device (e.g., UE). That is, a network entity may configure an IE, field, or parameter to allow a device (e.g., UE) to utilize positioning measurement IE reporting based on corresponding cells/areas or area IDs. In some instances, the configured IEs, fields, or parameters for the positioning measurement reporting may be associated with at least one of: an LoS or NLOS indicator request, additional path reporting, RSRP or path-RSRP reporting, RSRP for additional paths, a number of samples for PRS processing, whether to report an Rx TEG, or a number of RSRP or path RSRPs to report. As indicated herein, each of the IE, field, or parameter for positioning measurement reporting may be specific to the corresponding cells/areas or area IDs.

Aspects of the present disclosure may utilize a number of different examples of IEs that can be configured based on the corresponding cell/area or area ID of the device. In some aspects, a device may obtain a measurement and reporting configuration including a set of measurement parameters and/or a set of positioning measurement IEs, where the set of measurement parameters and/or the set of positioning measurement IEs is associated with a set of area IDs or corresponding cells/areas associated with the device. For instance, the set of measurement parameters and/or the set of positioning measurement IEs may be associated with area ID-based positioning measurements. In some instances, if the set of measurement parameters and/or the set of positioning measurement IEs are associated with area ID-based positioning measurements, the set of positioning measurement IEs may include at least one of: an LOS or NLOS indicator request IE or field, an additional path reporting IE or field, a RSRP or path-RSRP reporting IE or field, an RSRP for additional paths IE or field, a number of samples for PRS processing IE or field, a Rx TEG IE or field, or a number of RSRPs or path-RSRPs IE or field.

In some aspects, the set of measurement parameters and/or the set of positioning measurement IEs may be associated with downlink angle of departure (AoD) location information, and the set of positioning measurement IEs may include at least one of: a maximum downlink PRS RSRP measurement per TRP IE or field, an RSRP or first path RSRP measurement request IE or field, a line-of-sight (LOS) or non-LOS (NLOS) indicator request IE or field, and/or a requested downlink PRS processing sample IE or field. Additionally, the set of measurement parameters and/or the set of positioning measurement IEs may be associated with downlink TDOA location information, and the set of positioning measurement IEs may include at least one of: a requested measurement IE or field, an additional path IE or field, a UE reception (Rx) timing error group (TEG) request IE or field, a line-of-sight (LOS) or non-LOS (NLOS) indicator request IE or field, an additional path extension IE or field, an additional path downlink PRS RSRP request IE or field, a maximum downlink PRS RSTD measurement per TRP pair IE or field, a timing reporting granularity factor IE or field, a measure same downlink PRS resource with different Rx TEG IE or field, and/or a requested downlink PRS processing sample IE or field. Moreover, the set of measurement parameters and/or the set of positioning measurement IEs may be associated with multiple round trip time (multi-RTT) location information, and the set of positioning measurement IEs may include at least one of: a requested measurement IE or field, an additional path IE or field, a UE Rx-Tx TEG request IE or field, a measure same downlink PRS resource with different Rx-Tx TEG IE or field, a measure same downlink PRS resource with different Rx TEG IE or field, a requested downlink PRS processing sample IE or field, a line-of-sight (LOS) or non-LOS (NLOS) indicator request IE or field, an additional path extension IE or field, an additional path downlink PRS RSRP request IE or field, a maximum downlink PRS Rx-Tx time difference measurement per TRP IE or field, and/or a timing reporting granularity factor IE or field.

In some aspects, the area IDs for corresponding cells/areas may be associated with an assistance data (AD) configuration and/or a measurement and reporting configuration. That is, some area IDs for corresponding cells/areas may be associated with assistance data (AD) configuration, and other area IDs for corresponding cells/areas may be associated with a measurement and reporting configuration. For instance, the area IDs for the assistance data configuration may be associated with different TRPs compared to the area IDs for a measurement and reporting configuration. In some instances, a preconfigured AD configuration with a first assistance data configuration (AD1) and a second assistance data configuration (AD2) may be associated with a first area ID (AID1) and a second area ID (AID2), where each area ID corresponds to a first TRP (TRP1), a second TRP (TRP2), a third TRP (TRP3), or a fourth TRP (TRP4). For instance, AID1={TRP1, TRP2} for AD1, and AID2={TRP3, TRP4} for AD2. Additionally, a preconfigured measurement and reporting configuration with a first measurement/reporting configuration (MR1) and a second measurement/reporting configuration (MR2) may be associated with a first area ID (AID1) and a second area ID (AID2), where each area ID corresponds to a first TRP (TRP1), a second TRP (TRP2), a third TRP (TRP3), or a fourth TRP (TRP4). For instance, AID1={TRP1, TRP2, TRP3} for MR1, and AID2={TRP4} for MR2. Depending on which TRP a UE is camped on, it may use a different AD configuration or a measurement/reporting configuration. In one example, if a UE is camped on TRP1, then it may use the AD1 and the MR1. In another example, if a UE is camped on TRP3, then it may use the AD2 and the MR1.

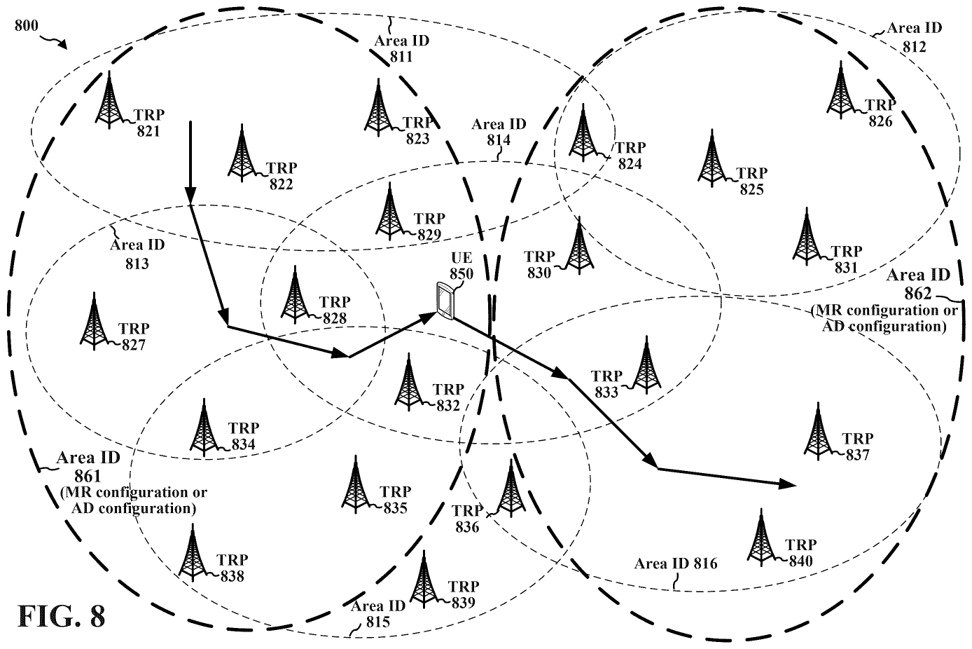

FIG. 8 is a diagram 800 illustrating an example region for positioning measurements. More specifically, FIG. 8 depicts a region for positioning measurements including a number of cells/areas associated with an area identifier (ID), as well as area IDs for measurement and reporting. As shown in FIG. 8, diagram 800 includes a number of cells (i.e., the dashed-line ellipses in FIG. 8) and associated area IDs (e.g., area ID 811, area ID 812, area ID 813, area ID 814, area ID 815, and area ID 816). Diagram 800 also depicts a number of transmission-reception points (TRPs) within the areas (e.g., TRP 821, TRP 822, TRP 823, TRP 824, TRP 825, TRP 826, TRP 827, TRP 828, TRP 829, TRP 830, TRP 831, TRP 832, TRP 833, TRP 834, TRP 835, TRP 836, TRP 837, TRP 838, TRP 839, and TRP 840), as well as UE 850. As shown by the arrows in FIG. 8, UE 850 is gradually moving through the different cells and associated area IDs. That is, UE 850 starts in the cell corresponding to area ID 811, then moves to the cell corresponding to area ID 813, then moves to the cell corresponding to area ID 815, then moves to the cell corresponding to area ID 814, and then moves to the cell corresponding to area ID 816. The movement of UE 850 corresponds to the cell on which the UE 850 is camped on or connected. As indicated above, each of the area IDs in FIG. 8 may be associated with a DL-PRS assistance data instance for pre-configured DL-PRS assistance data. As further shown in FIG. 8, diagram 800 includes a number of area IDs (and corresponding cells/areas) that are associated with measurement and reporting (MR) configurations (e.g., area ID 861 and area ID 862). As further indicated in FIG. 8, a number of area IDs (e.g., area ID 861 and area ID 862) (and corresponding cells/areas) may also be associated with assistance data (AD) configurations. That is, as shown in FIG. 8, area IDs (e.g., area ID 861 and area ID 862) may be associated with assistance data (AD) configurations and/or measurement and reporting (MR) configurations.

In some aspects, area IDs for corresponding cells/areas may be associated with an assistance data (AD) configuration and/or a measurement and reporting (MR) configuration. For instance, the area IDs for the assistance data configuration may be associated with the same TRPs compared to the area IDs for a measurement and reporting configuration. In some instances, a preconfigured AD configuration with a first assistance data configuration (AD1) and a second assistance data configuration (AD2), as well as preconfigured measurement and reporting configuration with a first measurement/reporting configuration (MR1) and a second measurement/reporting configuration (MR2), may be associated with a first area ID (AID1) and a second area ID (AID2), where each area ID corresponds to a first TRP (TRP1), a second TRP (TRP2), a third TRP (TRP3), or a fourth TRP (TRP4). For instance, AID1={TRP1, TRP2} for (AD1, MR1), and AID2={TRP3, TRP4} for (AD2, MR2). Depending on which TRP a UE is camped on, it may use a same corresponding AD configuration and/or a measurement/reporting configuration. In one example, if a UE is camped on TRP1, then it may use the AD1 and the MR1. In another example, if a UE is camped on TRP3, then it may use the AD2 and the MR2.

Aspects of the present disclosure may include a number of benefits or advantages. For example, aspects presented herein may configure or adjust the reporting conditions for a device based on a number of factors. Also, in some instances, aspects presented herein may configure or adjust the reporting conditions for a device based on a corresponding cell or area of the device. For instance, aspects presented herein may allow a network entity (e.g., LMF) to configure different report conditions for a device (e.g., UE). Indeed, aspects presented herein may a provide a network entity (e.g., LMF) the ability to configure different report conditions for a device (e.g., UE) based on a corresponding area ID or positioning measurement IE. Additionally, aspects presented herein may configure a number of different information elements (IEs), fields, and/or parameters in order to improve the reporting conditions for a device. Aspects of the present disclosure may allow a network entity to configure a number of different IEs, fields, and/or parameters for reporting positioning measurements and/or device environment information in order to improve the reporting conditions for a device. For example, the network entity (e.g., LMF) may configure the device (e.g., UE) to report improved information about the environment of the device no matter the corresponding area of the device. By doing so, this may allow the device (e.g., UE) to report improved information to the network entity (e.g., LMF) about the UE environment regardless of the corresponding area of the device (e.g., UE).

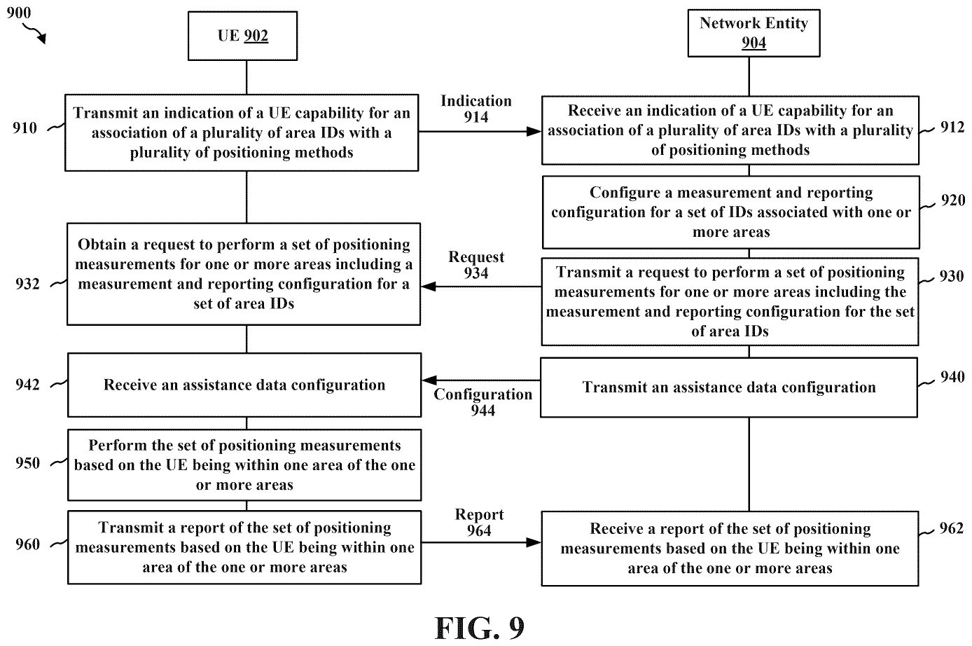

FIG. 9 is a communication flow diagram 900 of wireless communication in accordance with one or more techniques of this disclosure. As shown in FIG. 9, diagram 900 includes example communications between UE 902 (e.g., a UE or a wireless device) and a network entity 904 (e.g., a server or an LMF), in accordance with one or more techniques of this disclosure. In some aspects, UE 902 may be a first wireless device (e.g., UE, base station, TRP, or network entity) and network entity 904 may be a second wireless device (e.g., UE, base station, TRP, or network entity).

At 910, UE 902 may transmit, for a network entity (e.g., network entity 904), an indication of a UE capability (e.g., indication 914) for an association of a plurality of area identifiers (IDs) with a plurality of positioning methods, where the plurality of area IDs corresponds to a set of area IDs, and where the plurality of positioning methods corresponds to a set of positioning measurements.

At 912, network entity 904 may receive, from a UE (e.g., UE 902), an indication of a UE capability (e.g., indication 914) for an association of a plurality of area IDs with a plurality of positioning methods, where the plurality of area IDs corresponds to a set of area IDs, and where the plurality of positioning methods corresponds to a set of positioning measurements.

At 920, network entity 904 may configure a measurement and reporting configuration for a set of area identifiers (IDs) associated with one or more areas, where the measurement and reporting configuration includes information associated with a performance of a set of positioning measurements and a report of the set of positioning measurements. Also, each area ID in the set of area IDs may be associated with a set of transmission-reception point (TRP) IDs for a set of TRPs within the one or more areas.

At 930, network entity 904 may transmit, for a UE, a request to perform the set of positioning measurements for the one or more areas (e.g., request 934), where the request includes the measurement and reporting configuration for the set of area IDs associated with the one or more areas.

At 932, UE 902 may obtain a request to perform a set of positioning measurements for one or more areas (e.g., request 934), where the request includes a measurement and reporting configuration for a set of area identifiers (IDs) associated with the one or more areas, where the measurement and reporting configuration includes information associated with a performance of the set of positioning measurements and a report of the set of positioning measurements. Each area ID in the set of area IDs may be associated with a set of transmission-reception point (TRP) IDs for a set of TRPs within the one or more areas. In some aspects, obtaining the request to perform the set of positioning measurements for the one or more areas may include: receiving, from the network entity, the request to perform the set of positioning measurements for the one or more areas. That is, the UE may receive, from the network entity, the request to perform the set of positioning measurements for the one or more areas.

In some aspects, the measurement and reporting configuration may include at least one of a set of measurement parameters or a set of positioning measurement information elements (IEs), where at least one of the set of measurement parameters or the set of positioning measurement IEs may be associated with the set of area IDs. At least one of the set of measurement parameters or the set of positioning measurement IEs may be associated with downlink angle of departure (AoD) location information, and the set of positioning measurement IEs may include at least one of: a downlink positioning reference signal (PRS) reference signal received power (RSRP) measurement per transmission-reception point (TRP) IE, a reference signal received power (RSRP) or path-RSRP measurement request IE, a line-of-sight (LOS) or non-LOS (NLOS) indicator request IE, or a requested downlink PRS processing sample IE. Also, at least one of the set of measurement parameters or the set of positioning measurement IEs may be associated with downlink time difference of arrival (TDOA) location information, and the set of positioning measurement IEs may include at least one of: a requested measurement IE, an additional path IE, a reception (Rx) timing error group (TEG) request IE, a line-of-sight (LOS) or non-LOS (NLOS) indicator request IE, an additional path extension IE, an additional path downlink positioning reference signal (PRS) reference signal received power (RSRP) request IE, a downlink PRS reference signal time difference (RSTD) measurement per transmission-reception point (TRP) pair IE, a timing reporting granularity factor IE, a measure same downlink PRS resource with different reception (Rx) timing error group (TEG) IE, or a requested downlink PRS processing sample IE. Further, at least one of the set of measurement parameters or the set of positioning measurement IEs may be associated with an area ID-based positioning measurement, where the set of positioning measurement IEs may include at least one of: a line-of-sight (LOS) or non-LOS (NLOS) indicator request IE, an additional path reporting IE, a reference signal received power (RSRP) or path-RSRP reporting IE, an RSRP for additional paths IE, a number of samples for positioning reference signal (PRS) processing IE, a reception (Rx) timing error group (TEG) IE, or a number of RSRPs or path-RSRPs IE. Moreover, at least one of the set of measurement parameters or the set of positioning measurement IEs may be associated with multiple round trip time (multi-RTT) location information, and the set of positioning measurement IEs may include at least one of: a requested measurement IE, an additional path IE, a reception (Rx)-transmission (Tx) timing error group (TEG) request IE, a measure same downlink positioning reference signal (PRS) resource with different Rx-Tx TEG IE, a measure same downlink PRS resource with different Rx TEG IE, a requested downlink PRS processing sample IE, a line-of-sight (LOS) or non-LOS (NLOS) indicator request IE, an additional path extension IE, an additional path downlink PRS reference signal received power (RSRP) request IE, a downlink PRS Rx-Tx time difference measurement per transmission-reception point (TRP) IE, or a timing reporting granularity factor IE.

At 940, network entity 904 may transmit an assistance data configuration (e.g., configuration 944) for the UE 902, where at least one first area ID in the set of area IDs is associated with the assistance data configuration. In some aspects, the at least one first area ID in the set of area IDs associated with the assistance data configuration may be identical to at least one second area ID in the set of area IDs associated with the measurement and reporting configuration. Also, the at least one first area ID in the set of area IDs associated with the assistance data configuration may be different from at least one second area ID in the set of area IDs associated with the measurement and reporting configuration. In some aspects, a second set of area IDs may be associated with assistance data (AD) for the one or more areas, where the second set of area IDs may include different transmission-reception points (TRPs) compared to the set of area IDs for the measurement and reporting configuration.

At 942, UE 902 may receive an assistance data configuration (e.g., configuration 944) from the network entity 904, where at least one first area ID in the set of area IDs is associated with the assistance data configuration. In some aspects, the at least one first area ID in the set of area IDs associated with the assistance data configuration may be identical to at least one second area ID in the set of area IDs associated with the measurement and reporting configuration. Also, the at least one first area ID in the set of area IDs associated with the assistance data configuration may be different from at least one second area ID in the set of area IDs associated with the measurement and reporting configuration. In some aspects, a second set of area IDs may be associated with assistance data (AD) for the one or more areas, where the second set of area IDs may include different transmission-reception points (TRPs) compared to the set of area IDs for the measurement and reporting configuration.

At 950, UE 902 may perform the set of positioning measurements based on the UE being within one area of the one or more areas associated with the set of area IDs.

At 960, UE 902 may transmit, for a network entity after the performance of the set of positioning measurements, the report of the set of positioning measurements (e.g., report 964) based on the UE being within the one area of the one or more areas associated with the set of area IDs. Also, the one area of the one or more areas may correspond to an area in which the UE is camped on a transmission-reception point (TRP) in a set of TRPs within the one or more areas.

At 962, network entity 904 may receive the report of the set of positioning measurements (e.g., report 964) based on the UE being within one area of the one or more areas. Additionally, the one area of the one or more areas may correspond to an area in which the UE is camped on a transmission-reception point (TRP) in a set of TRPs within the one or more areas.

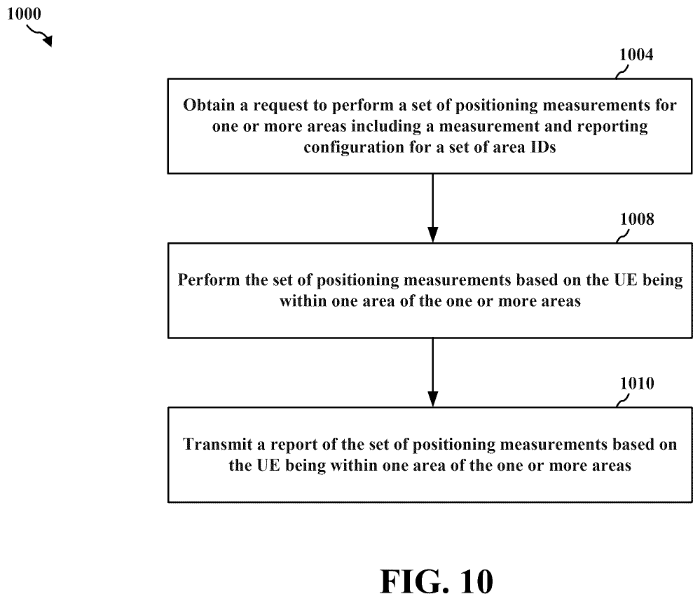

FIG. 10 is a flowchart 1000 of a method of wireless communication. The method may be performed by a wireless device or a UE (e.g., UE 104, UE 602, UE 750, UE 850, UE 902; apparatus 1404). The methods described herein may provide a number of benefits, such as improving resource utilization and/or power savings.

At 1004, the UE may obtain a request to perform a set of positioning measurements for one or more areas, where the request includes a measurement and reporting configuration for a set of area identifiers (IDs) associated with the one or more areas, where the measurement and reporting configuration includes information associated with a performance of the set of positioning measurements and a report of the set of positioning measurements, as discussed with respect to FIGS. 4-9. For example, as described in 932 of FIG. 9, the UE 902 may obtain a request to perform a set of positioning measurements for one or more areas, where the request includes a measurement and reporting configuration for a set of area identifiers (IDs) associated with the one or more areas, where the measurement and reporting configuration includes information associated with a performance of the set of positioning measurements and a report of the set of positioning measurements. Further, step 1004 may be performed by location component 198. Each area ID in the set of area IDs may be associated with a set of transmission-reception point (TRP) IDs for a set of TRPs within the one or more areas. In some aspects, obtaining the request to perform the set of positioning measurements for the one or more areas may include: receiving, from the network entity, the request to perform the set of positioning measurements for the one or more areas. That is, the UE may receive, from the network entity, the request to perform the set of positioning measurements for the one or more areas.

In some aspects, the measurement and reporting configuration may include at least one of a set of measurement parameters or a set of positioning measurement information elements (IEs), where at least one of the set of measurement parameters or the set of positioning measurement IEs may be associated with the set of area IDs. At least one of the set of measurement parameters or the set of positioning measurement IEs may be associated with downlink angle of departure (AoD) location information, and the set of positioning measurement IEs may include at least one of: a downlink positioning reference signal (PRS) reference signal received power (RSRP) measurement per transmission-reception point (TRP) IE, a reference signal received power (RSRP) or path-RSRP measurement request IE, a line-of-sight (LOS) or non-LOS (NLOS) indicator request IE, or a requested downlink PRS processing sample IE. Also, at least one of the set of measurement parameters or the set of positioning measurement IEs may be associated with downlink time difference of arrival (TDOA) location information, and the set of positioning measurement IEs may include at least one of: a requested measurement IE, an additional path IE, a reception (Rx) timing error group (TEG) request IE, a line-of-sight (LOS) or non-LOS (NLOS) indicator request IE, an additional path extension IE, an additional path downlink positioning reference signal (PRS) reference signal received power (RSRP) request IE, a downlink PRS reference signal time difference (RSTD) measurement per transmission-reception point (TRP) pair IE, a timing reporting granularity factor IE, a measure same downlink PRS resource with different reception (Rx) timing error group (TEG) IE, or a requested downlink PRS processing sample IE. Further, at least one of the set of measurement parameters or the set of positioning measurement IEs may be associated with an area ID-based positioning measurement, where the set of positioning measurement IEs may include at least one of: a line-of-sight (LOS) or non-LOS (NLOS) indicator request IE, an additional path reporting IE, a reference signal received power (RSRP) or path-RSRP reporting IE, an RSRP for additional paths IE, a number of samples for positioning reference signal (PRS) processing IE, a reception (Rx) timing error group (TEG) IE, or a number of RSRPs or path-RSRPs IE. Moreover, at least one of the set of measurement parameters or the set of positioning measurement IEs may be associated with multiple round trip time (multi-RTT) location information, and the set of positioning measurement IEs may include at least one of: a requested measurement IE, an additional path IE, a reception (Rx)-transmission (Tx) timing error group (TEG) request IE, a measure same downlink positioning reference signal (PRS) resource with different Rx-Tx TEG IE, a measure same downlink PRS resource with different Rx TEG IE, a requested downlink PRS processing sample IE, a line-of-sight (LOS) or non-LOS (NLOS) indicator request IE, an additional path extension IE, an additional path downlink PRS reference signal received power (RSRP) request IE, a downlink PRS Rx-Tx time difference measurement per transmission-reception point (TRP) IE, or a timing reporting granularity factor IE.

At 1008, the UE may perform the set of positioning measurements based on the UE being within one area of the one or more areas associated with the set of area IDs, as discussed with respect to FIGS. 4-9. For example, as described in 950 of FIG. 9, the UE 902 may perform the set of positioning measurements based on the UE being within one area of the one or more areas associated with the set of area IDs. Further, step 1008 may be performed by location component 198.

At 1010, the UE may transmit, for a network entity after the performance of the set of positioning measurements, the report of the set of positioning measurements based on the UE being within the one area of the one or more areas associated with the set of area IDs, as discussed with respect to FIGS. 4-9. For example, as described in 960 of FIG. 9, the UE 902 may transmit, for a network entity after the performance of the set of positioning measurements, the report of the set of positioning measurements based on the UE being within the one area of the one or more areas associated with the set of area IDs. Further, step 1010 may be performed by location component 198. Also, the one area of the one or more areas may correspond to an area in which the UE is camped on a transmission-reception point (TRP) in a set of TRPs within the one or more areas.

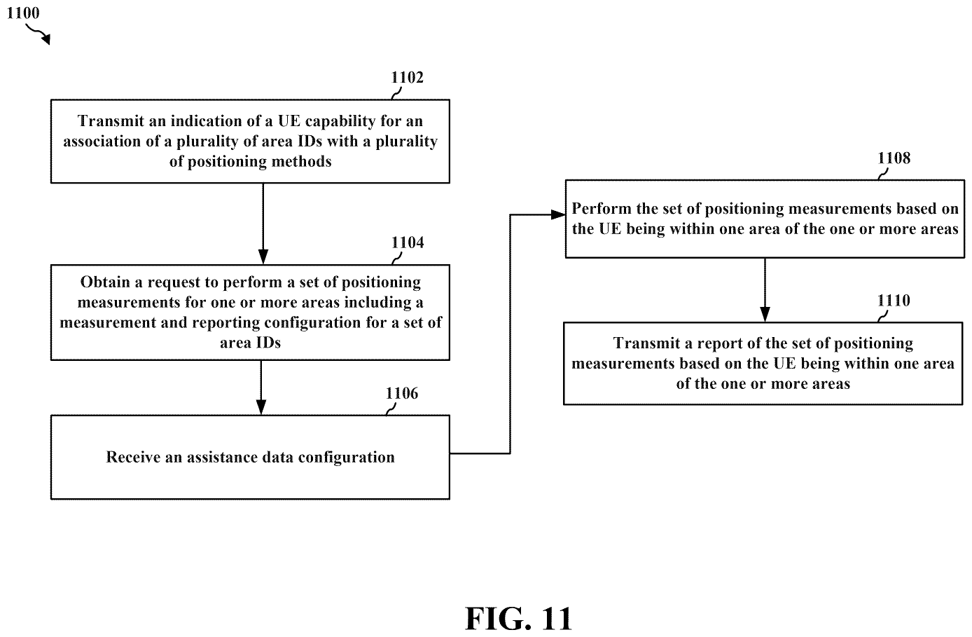

FIG. 11 is a flowchart 1100 of a method of wireless communication. The method may be performed by a wireless device or a UE (e.g., UE 104, UE 602, UE 750, UE 850, UE 902; apparatus 1404). The methods described herein may provide a number of benefits, such as improving resource utilization and/or power savings.

At 1102, the UE may transmit, for a network entity, an indication of a UE capability for an association of a plurality of area identifiers (IDs) with a plurality of positioning methods, where the plurality of area IDs may correspond to a set of area IDs, and where the plurality of positioning methods may correspond to a set of positioning measurements, as discussed with respect to FIGS. 4-9. For example, as described in 910 of FIG. 9, the UE 902 may transmit, for a network entity, an indication of a UE capability for an association of a plurality of area identifiers (IDs) with a plurality of positioning methods, where the plurality of area IDs may correspond to a set of area IDs, and where the plurality of positioning methods may correspond to a set of positioning measurements. Further, step 1102 may be performed by location component 198.

At 1104, the UE may obtain a request to perform a set of positioning measurements for one or more areas, where the request includes a measurement and reporting configuration for a set of area identifiers (IDs) associated with the one or more areas, where the measurement and reporting configuration includes information associated with a performance of the set of positioning measurements and a report of the set of positioning measurements, as discussed with respect to FIGS. 4-9. For example, as described in 932 of FIG. 9, the UE 902 may obtain a request to perform a set of positioning measurements for one or more areas, where the request includes a measurement and reporting configuration for a set of area identifiers (IDs) associated with the one or more areas, where the measurement and reporting configuration includes information associated with a performance of the set of positioning measurements and a report of the set of positioning measurements. Further, step 1104 may be performed by location component 198. Each area ID in the set of area IDs may be associated with a set of transmission-reception point (TRP) IDs for a set of TRPs within the one or more areas. In some aspects, obtaining the request to perform the set of positioning measurements for the one or more areas may include: receiving, from the network entity, the request to perform the set of positioning measurements for the one or more areas. That is, the UE may receive, from the network entity, the request to perform the set of positioning measurements for the one or more areas.

In some aspects, the measurement and reporting configuration may include at least one of a set of measurement parameters or a set of positioning measurement information elements (IEs), where at least one of the set of measurement parameters or the set of positioning measurement IEs may be associated with the set of area IDs. At least one of the set of measurement parameters or the set of positioning measurement IEs may be associated with downlink angle of departure (AoD) location information, and the set of positioning measurement IEs may include at least one of: a downlink positioning reference signal (PRS) reference signal received power (RSRP) measurement per transmission-reception point (TRP) IE, a reference signal received power (RSRP) or path-RSRP measurement request IE, a line-of-sight (LOS) or non-LOS (NLOS) indicator request IE, or a requested downlink PRS processing sample IE. Also, at least one of the set of measurement parameters or the set of positioning measurement IEs may be associated with downlink time difference of arrival (TDOA) location information, and the set of positioning measurement IEs may include at least one of: a requested measurement IE, an additional path IE, a reception (Rx) timing error group (TEG) request IE, a line-of-sight (LOS) or non-LOS (NLOS) indicator request IE, an additional path extension IE, an additional path downlink positioning reference signal (PRS) reference signal received power (RSRP) request IE, a downlink PRS reference signal time difference (RSTD) measurement per transmission-reception point (TRP) pair IE, a timing reporting granularity factor IE, a measure same downlink PRS resource with different reception (Rx) timing error group (TEG) IE, or a requested downlink PRS processing sample IE. Further, at least one of the set of measurement parameters or the set of positioning measurement IEs may be associated with an area ID-based positioning measurement, where the set of positioning measurement IEs may include at least one of: a line-of-sight (LOS) or non-LOS (NLOS) indicator request IE, an additional path reporting IE, a reference signal received power (RSRP) or path-RSRP reporting IE, an RSRP for additional paths IE, a number of samples for positioning reference signal (PRS) processing IE, a reception (Rx) timing error group (TEG) IE, or a number of RSRPs or path-RSRPs IE. Moreover, at least one of the set of measurement parameters or the set of positioning measurement IEs may be associated with multiple round trip time (multi-RTT) location information, and the set of positioning measurement IEs may include at least one of: a requested measurement IE, an additional path IE, a reception (Rx)-transmission (Tx) timing error group (TEG) request IE, a measure same downlink positioning reference signal (PRS) resource with different Rx-Tx TEG IE, a measure same downlink PRS resource with different Rx TEG IE, a requested downlink PRS processing sample IE, a line-of-sight (LOS) or non-LOS (NLOS) indicator request IE, an additional path extension IE, an additional path downlink PRS reference signal received power (RSRP) request IE, a downlink PRS Rx-Tx time difference measurement per transmission-reception point (TRP) IE, or a timing reporting granularity factor IE.

At 1106, the UE may receive an assistance data configuration from a network entity, where at least one first area ID in the set of area IDs is associated with the assistance data configuration, as discussed with respect to FIGS. 4-9. For example, as described in 942 of FIG. 9, the UE 902 may receive an assistance data configuration from a network entity, where at least one first area ID in the set of area IDs is associated with the assistance data configuration. Further, step 1106 may be performed by location component 198. In some aspects, the at least one first area ID in the set of area IDs associated with the assistance data configuration may be identical to at least one second area ID in the set of area IDs associated with the measurement and reporting configuration. Also, the at least one first area ID in the set of area IDs associated with the assistance data configuration may be different from at least one second area ID in the set of area IDs associated with the measurement and reporting configuration. In some aspects, a second set of area IDs may be associated with assistance data (AD) for the one or more areas, where the second set of area IDs may include different transmission-reception points (TRPs) compared to the set of area IDs for the measurement and reporting configuration.

At 1108, the UE may perform the set of positioning measurements based on the UE being within one area of the one or more areas associated with the set of area IDs, as discussed with respect to FIGS. 4-9. For example, as described in 950 of FIG. 9, the UE 902 may perform the set of positioning measurements based on the UE being within one area of the one or more areas associated with the set of area IDs. Further, step 1108 may be performed by location component 198.

At 1110, the UE may transmit, for a network entity after the performance of the set of positioning measurements, the report of the set of positioning measurements based on the UE being within the one area of the one or more areas associated with the set of area IDs, as discussed with respect to FIGS. 4-9. For example, as described in 960 of FIG. 9, the UE 902 may transmit, for a network entity after the performance of the set of positioning measurements, the report of the set of positioning measurements based on the UE being within the one area of the one or more areas associated with the set of area IDs. Further, step 1110 may be performed by location component 198. Also, the one area of the one or more areas may correspond to an area in which the UE is camped on a transmission-reception point (TRP) in a set of TRPs within the one or more areas.

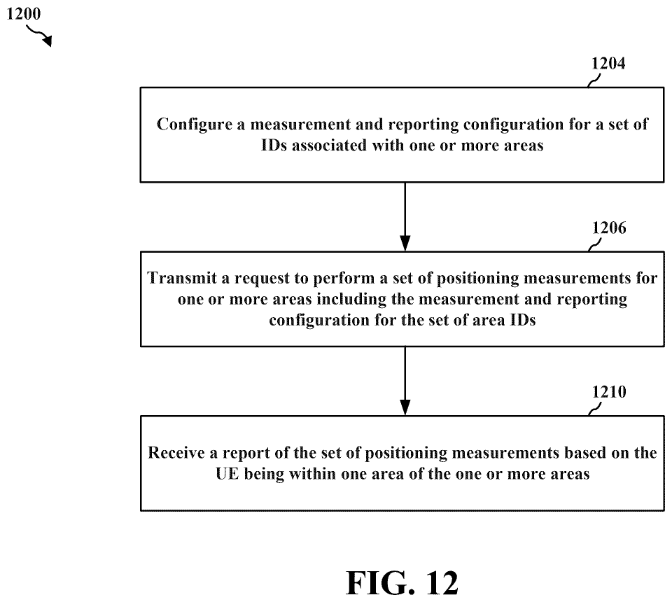

FIG. 12 is a flowchart 1200 of a method of wireless communication. The method may be performed by a network entity, a server, or an LMF (e.g., LMF 166; set of locations servers 168; LMF 606; network entity 904; network entity 1502; network entity 1660). The methods described herein may provide a number of benefits, such as improving resource utilization and/or power savings.

At 1204, the network entity may configure a measurement and reporting configuration for a set of area identifiers (IDs) associated with one or more areas, where the measurement and reporting configuration includes information associated with a performance of a set of positioning measurements and a report of the set of positioning measurements, as discussed with respect to FIGS. 4-9. For example, as described in 920 of FIG. 9, network entity 904 may configure a measurement and reporting configuration for a set of area identifiers (IDs) associated with one or more areas, where the measurement and reporting configuration includes information associated with a performance of a set of positioning measurements and a report of the set of positioning measurements. Further, step 1204 may be performed by location component 199. Also, each area ID in the set of area IDs may be associated with a set of transmission-reception point (TRP) IDs for a set of TRPs within the one or more areas.

In some aspects, the measurement and reporting configuration may include at least one of a set of measurement parameters or a set of positioning measurement information elements (IEs), where at least one of the set of measurement parameters or the set of positioning measurement IEs may be associated with the set of area IDs. At least one of the set of measurement parameters or the set of positioning measurement IEs may be associated with downlink angle of departure (AoD) location information, and the set of positioning measurement IEs may include at least one of: a downlink positioning reference signal (PRS) reference signal received power (RSRP) measurement per transmission-reception point (TRP) IE, a reference signal received power (RSRP) or path-RSRP measurement request IE, a line-of-sight (LOS) or non-LOS (NLOS) indicator request IE, or a requested downlink PRS processing sample IE. Also, at least one of the set of measurement parameters or the set of positioning measurement IEs may be associated with downlink time difference of arrival (TDOA) location information, and the set of positioning measurement IEs may include at least one of: a requested measurement IE, an additional path IE, a reception (Rx) timing error group (TEG) request IE, a line-of-sight (LOS) or non-LOS (NLOS) indicator request IE, an additional path extension IE, an additional path downlink positioning reference signal (PRS) reference signal received power (RSRP) request IE, a downlink PRS reference signal time difference (RSTD) measurement per transmission-reception point (TRP) pair IE, a timing reporting granularity factor IE, a measure same downlink PRS resource with different reception (Rx) timing error group (TEG) IE, or a requested downlink PRS processing sample IE. Further, at least one of the set of measurement parameters or the set of positioning measurement IEs may be associated with an area ID-based positioning measurement, where the set of positioning measurement IEs may include at least one of: a line-of-sight (LOS) or non-LOS (NLOS) indicator request IE, an additional path reporting IE, a reference signal received power (RSRP) or path-RSRP reporting IE, an RSRP for additional paths IE, a number of samples for positioning reference signal (PRS) processing IE, a reception (Rx) timing error group (TEG) IE, or a number of RSRPs or path-RSRPs IE. Moreover, at least one of the set of measurement parameters or the set of positioning measurement IEs may be associated with multiple round trip time (multi-RTT) location information, and the set of positioning measurement IEs may include at least one of: a requested measurement IE, an additional path IE, a reception (Rx)-transmission (Tx) timing error group (TEG) request IE, a measure same downlink positioning reference signal (PRS) resource with different Rx-Tx TEG IE, a measure same downlink PRS resource with different Rx TEG IE, a requested downlink PRS processing sample IE, a line-of-sight (LOS) or non-LOS (NLOS) indicator request IE, an additional path extension IE, an additional path downlink PRS reference signal received power (RSRP) request IE, a downlink PRS Rx-Tx time difference measurement per transmission-reception point (TRP) IE, or a timing reporting granularity factor IE.

At 1206, the network entity may transmit, for a user equipment (UE), a request to perform the set of positioning measurements for the one or more areas, where the request may include the measurement and reporting configuration for the set of area IDs associated with the one or more areas, as discussed with respect to FIGS. 4-9. For example, as described in 930 of FIG. 9, network entity 904 may transmit, for a user equipment (UE), a request to perform the set of positioning measurements for the one or more areas, where the request may include the measurement and reporting configuration for the set of area IDs associated with the one or more areas. Further, step 1206 may be performed by location component 199.

At 1210, the network entity may receive the report of the set of positioning measurements based on the UE being within one area of the one or more areas, as discussed with respect to FIGS. 4-9. For example, as described in 962 of FIG. 9, network entity 904 may receive the report of the set of positioning measurements based on the UE being within one area of the one or more areas. Further, step 1210 may be performed by location component 199. Additionally, the one area of the one or more areas may correspond to an area in which the UE is camped on a transmission-reception point (TRP) in a set of TRPs within the one or more areas.

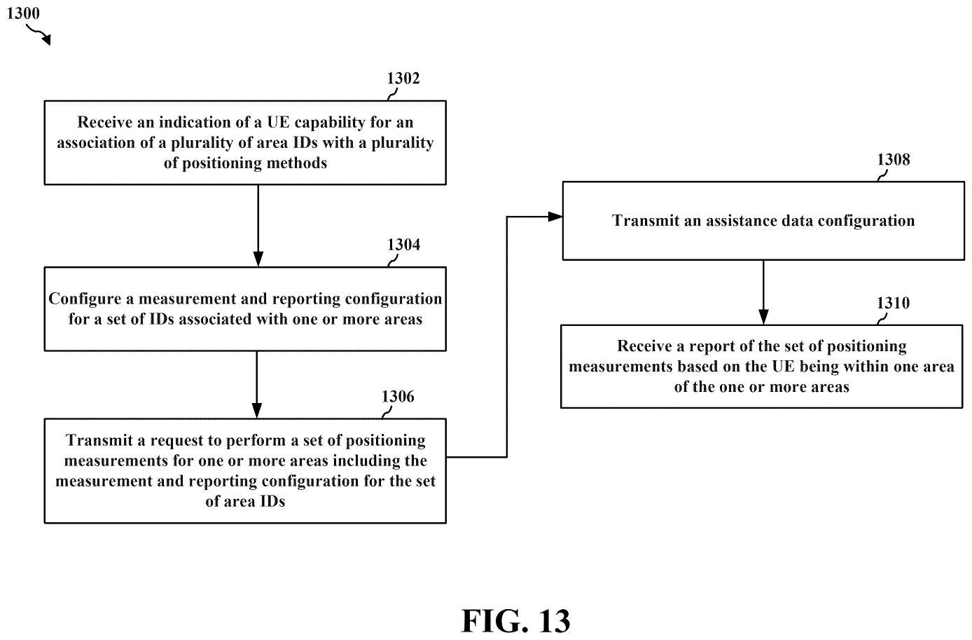

FIG. 13 is a flowchart 1300 of a method of wireless communication. The method may be performed by a network entity, a server, or an LMF (e.g., LMF 166; set of locations servers 168; LMF 606; network entity 904; network entity 1502; network entity 1660). The methods described herein may provide a number of benefits, such as improving resource utilization and/or power savings.

At 1302, the network entity may receive, from a UE, an indication of a UE capability for an association of a plurality of area IDs with a plurality of positioning methods, where the plurality of area IDs may correspond to a set of area IDs, and where the plurality of positioning methods may correspond to a set of positioning measurements, as discussed with respect to FIGS. 4-9. For example, as described in 912 of FIG. 9, network entity 904 may receive, from a UE, an indication of a UE capability for an association of a plurality of area IDs with a plurality of positioning methods, where the plurality of area IDs may correspond to a set of area IDs, and where the plurality of positioning methods may correspond to a set of positioning measurements. Further, step 1302 may be performed by location component 199.

At 1304, the network entity may configure a measurement and reporting configuration for a set of area identifiers (IDs) associated with one or more areas, where the measurement and reporting configuration includes information associated with a performance of a set of positioning measurements and a report of the set of positioning measurements, as discussed with respect to FIGS. 4-9. For example, as described in 920 of FIG. 9, network entity 904 may configure a measurement and reporting configuration for a set of area identifiers (IDs) associated with one or more areas, where the measurement and reporting configuration includes information associated with a performance of a set of positioning measurements and a report of the set of positioning measurements. Further, step 1304 may be performed by location component 199. Also, each area ID in the set of area IDs may be associated with a set of transmission-reception point (TRP) IDs for a set of TRPs within the one or more areas.

In some aspects, the measurement and reporting configuration may include at least one of a set of measurement parameters or a set of positioning measurement information elements (IEs), where at least one of the set of measurement parameters or the set of positioning measurement IEs may be associated with the set of area IDs. At least one of the set of measurement parameters or the set of positioning measurement IEs may be associated with downlink angle of departure (AoD) location information, and the set of positioning measurement IEs may include at least one of: a downlink positioning reference signal (PRS) reference signal received power (RSRP) measurement per transmission-reception point (TRP) IE, a reference signal received power (RSRP) or path-RSRP measurement request IE, a line-of-sight (LOS) or non-LOS (NLOS) indicator request IE, or a requested downlink PRS processing sample IE. Also, at least one of the set of measurement parameters or the set of positioning measurement IEs may be associated with downlink time difference of arrival (TDOA) location information, and the set of positioning measurement IEs may include at least one of: a requested measurement IE, an additional path IE, a reception (Rx) timing error group (TEG) request IE, a line-of-sight (LOS) or non-LOS (NLOS) indicator request IE, an additional path extension IE, an additional path downlink positioning reference signal (PRS) reference signal received power (RSRP) request IE, a downlink PRS reference signal time difference (RSTD) measurement per transmission-reception point (TRP) pair IE, a timing reporting granularity factor IE, a measure same downlink PRS resource with different reception (Rx) timing error group (TEG) IE, or a requested downlink PRS processing sample IE. Further, at least one of the set of measurement parameters or the set of positioning measurement IEs may be associated with an area ID-based positioning measurement, where the set of positioning measurement IEs may include at least one of: a line-of-sight (LOS) or non-LOS (NLOS) indicator request IE, an additional path reporting IE, a reference signal received power (RSRP) or path-RSRP reporting IE, an RSRP for additional paths IE, a number of samples for positioning reference signal (PRS) processing IE, a reception (Rx) timing error group (TEG) IE, or a number of RSRPs or path-RSRPs IE. Moreover, at least one of the set of measurement parameters or the set of positioning measurement IEs may be associated with multiple round trip time (multi-RTT) location information, and the set of positioning measurement IEs may include at least one of: a requested measurement IE, an additional path IE, a reception (Rx)-transmission (Tx) timing error group (TEG) request IE, a measure same downlink positioning reference signal (PRS) resource with different Rx-Tx TEG IE, a measure same downlink PRS resource with different Rx TEG IE, a requested downlink PRS processing sample IE, a line-of-sight (LOS) or non-LOS (NLOS) indicator request IE, an additional path extension IE, an additional path downlink PRS reference signal received power (RSRP) request IE, a downlink PRS Rx-Tx time difference measurement per transmission-reception point (TRP) IE, or a timing reporting granularity factor IE.

At 1306, the network entity may transmit, for a user equipment (UE), a request to perform the set of positioning measurements for the one or more areas, where the request may include the measurement and reporting configuration for the set of area IDs associated with the one or more areas, as discussed with respect to FIGS. 4-9. For example, as described in 930 of FIG. 9, network entity 904 may transmit, for a user equipment (UE), a request to perform the set of positioning measurements for the one or more areas, where the request may include the measurement and reporting configuration for the set of area IDs associated with the one or more areas. Further, step 1306 may be performed by location component 199.

At 1308, the network entity may transmit an assistance data configuration for the UE, where at least one first area ID in the set of area IDs may be associated with the assistance data configuration, as discussed with respect to FIGS. 4-9. For example, as described in 940 of FIG. 9, network entity 904 may transmit an assistance data configuration for the UE, where at least one first area ID in the set of area IDs may be associated with the assistance data configuration. Further, step 1308 may be performed by location component 199. In some aspects, the at least one first area ID in the set of area IDs associated with the assistance data configuration may be identical to at least one second area ID in the set of area IDs associated with the measurement and reporting configuration. Also, the at least one first area ID in the set of area IDs associated with the assistance data configuration may be different from at least one second area ID in the set of area IDs associated with the measurement and reporting configuration. In some aspects, a second set of area IDs may be associated with assistance data (AD) for the one or more areas, where the second set of area IDs may include different transmission-reception points (TRPs) compared to the set of area IDs for the measurement and reporting configuration.

At 1310, the network entity may receive the report of the set of positioning measurements based on the UE being within one area of the one or more areas, as discussed with respect to FIGS. 4-9. For example, as described in 962 of FIG. 9, network entity 904 may receive the report of the set of positioning measurements based on the UE being within one area of the one or more areas. Further, step 1310 may be performed by location component 199. Additionally, the one area of the one or more areas may correspond to an area in which the UE is camped on a transmission-reception point (TRP) in a set of TRPs within the one or more areas.

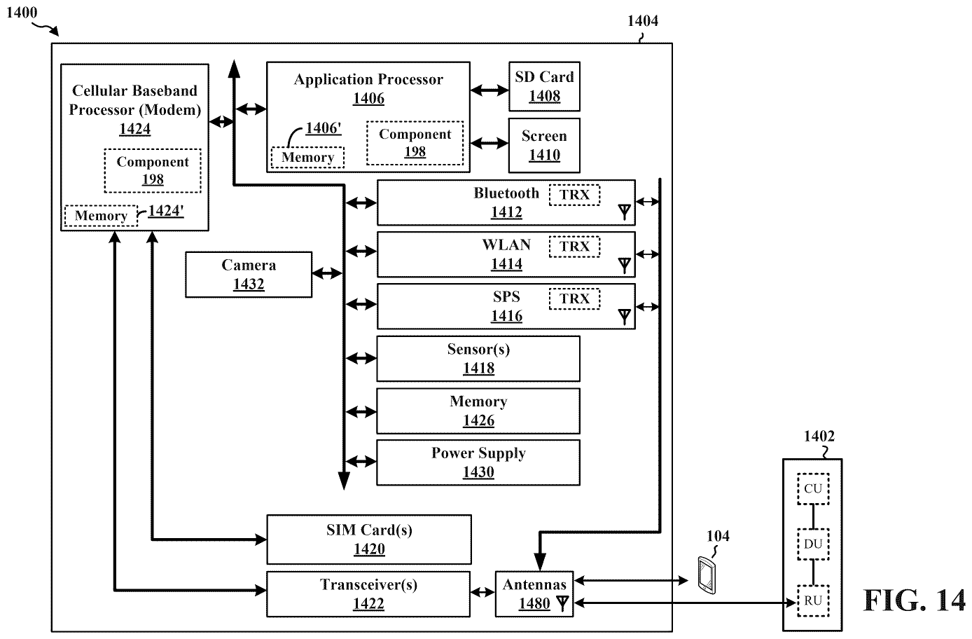

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include a cellular baseband processor 1424 (also referred to as a modem) coupled to one or more transceivers 1422 (e.g., cellular RF transceiver). The cellular baseband processor 1424 may include on-chip memory 1424′. In some aspects, the apparatus 1404 may further include one or more subscriber identity modules (SIM) cards 1420 and an application processor 1406 coupled to a secure digital (SD) card 1408 and a screen 1410. The application processor 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial management unit (IMU), gyroscope, and/or accelerometer(s); magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor 1424 communicates through the transceiver(s) 1422 via one or more antennas 1480 with the UE 104 and/or with an RU associated with a network entity 1402. The cellular baseband processor 1424 and the application processor 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor 1424 and the application processor 1406 are each responsible for general processing, including the execution of software stored on the computer-readable medium/memory. The software, when executed by the cellular baseband processor 1424/application processor 1406, causes the cellular baseband processor 1424/application processor 1406 to perform the various functions described supra. The computer-readable medium/memory may also be used for storing data that is manipulated by the cellular baseband processor 1424/application processor 1406 when executing software. The cellular baseband processor 1424/application processor 1406 may be a component of the UE 350 and may include the memory 360 and/or at least one of the TX processor 368, the RX processor 356, and the controller/processor 359. In one configuration, the apparatus 1404 may be a processor chip (modem and/or application) and include just the cellular baseband processor 1424 and/or the application processor 1406, and in another configuration, the apparatus 1404 may be the entire UE (e.g., see 350 of FIG. 3) and include the additional modules of the apparatus 1404.

As discussed supra, the location component 198 may be configured to obtain a request to perform a set of positioning measurements for one or more areas, where the request includes a measurement and reporting configuration for a set of area identifiers (IDs) associated with the one or more areas, where the measurement and reporting configuration includes information associated with a performance of the set of positioning measurements and a report of the set of positioning measurements. The location component 198 may also be configured to perform the set of positioning measurements based on the UE being within one area of the one or more areas associated with the set of area IDs. The location component 198 may also be configured to transmit, for a network entity after the performance of the set of positioning measurements, the report of the set of positioning measurements based on the UE being within the one area of the one or more areas associated with the set of area IDs. The location component 198 may also be configured to receive an assistance data configuration from the network entity, where at least one first area ID in the set of area IDs is associated with the assistance data configuration. The location component 198 may also be configured to transmit, for the network entity, an indication of a UE capability for an association of a plurality of area IDs with a plurality of positioning methods, where the plurality of area IDs corresponds to the set of area IDs, and where the plurality of positioning methods corresponds to the set of positioning measurements.

The location component 198 may be within the cellular baseband processor 1424, the application processor 1406, or both the cellular baseband processor 1424 and the application processor 1406. The location component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1404 may include a variety of components configured for various functions. In one configuration, the apparatus 1404, and in particular the cellular baseband processor 1424 and/or the application processor 1406, includes means for obtaining a request to perform a set of positioning measurements for one or more areas, where the request includes a measurement and reporting configuration for a set of area identifiers (IDs) associated with the one or more areas, where the measurement and reporting configuration includes information associated with a performance of the set of positioning measurements and a report of the set of positioning measurements. The apparatus 1404 may also include means for performing the set of positioning measurements based on the UE being within one area of the one or more areas associated with the set of area IDs. The apparatus 1404 may also include means for transmitting, for a network entity after the performance of the set of positioning measurements, the report of the set of positioning measurements based on the UE being within the one area of the one or more areas associated with the set of area IDs. The apparatus 1404 may also include means for receiving an assistance data configuration from the network entity, where at least one first area ID in the set of area IDs is associated with the assistance data configuration. The apparatus 1404 may also include means for transmitting, for the network entity, an indication of a UE capability for an association of a plurality of area IDs with a plurality of positioning methods, where the plurality of area IDs corresponds to the set of area IDs, and where the plurality of positioning methods corresponds to the set of positioning measurements. The means may be the location component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

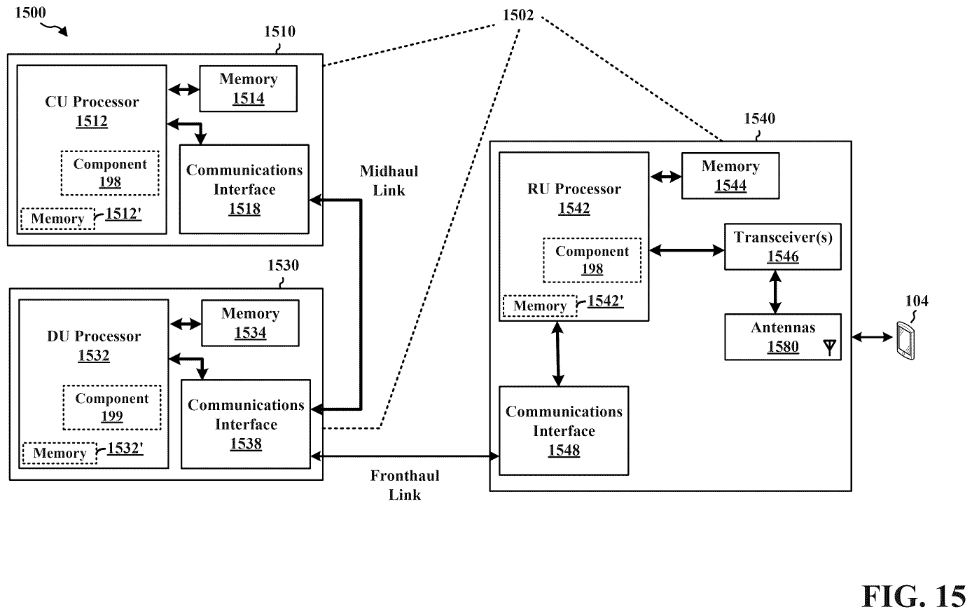

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the location component 198, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include a CU processor 1512. The CU processor 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include a DU processor 1532. The DU processor 1532 may include on-chip memory 1532′. In some aspects, the DU 1530 may further include additional memory modules 1534 and a communications interface 1538. The DU 1530 communicates with the RU 1540 through a fronthaul link. The RU 1540 may include an RU processor 1542. The RU processor 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the location component 198 may be configured to configure a measurement and reporting configuration for a set of area identifiers (IDs) associated with one or more areas, where the measurement and reporting configuration includes information associated with a performance of a set of positioning measurements and a report of the set of positioning measurements. The location component 198 may also be configured to transmit, for a user equipment (UE), a request to perform the set of positioning measurements for the one or more areas, where the request includes the measurement and reporting configuration for the set of area IDs associated with the one or more areas. The location component 198 may also be configured to receive the report of the set of positioning measurements based on the UE being within one area of the one or more areas. The location component 198 may also be configured to transmit an assistance data configuration for the UE, where at least one first area ID in the set of area IDs is associated with the assistance data configuration. The location component 198 may also be configured to receive, from the UE, an indication of a UE capability for an association of a plurality of area IDs with a plurality of positioning methods, where the plurality of area IDs corresponds to the set of area IDs, and where the plurality of positioning methods corresponds to the set of positioning measurements.

The location component 198 may be within one or more processors of one or more of the CU 1510, DU 1530, and the RU 1540. The location component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1502 may include a variety of components configured for various functions. In one configuration, the network entity 1502 may include means for configuring a measurement and reporting configuration for a set of area identifiers (IDs) associated with one or more areas, where the measurement and reporting configuration includes information associated with a performance of a set of positioning measurements and a report of the set of positioning measurements. The network entity 1502 may also include means for transmitting, for a user equipment (UE), a request to perform the set of positioning measurements for the one or more areas, where the request includes the measurement and reporting configuration for the set of area IDs associated with the one or more areas. The network entity 1502 may also include means for receiving the report of the set of positioning measurements based on the UE being within one area of the one or more areas. The network entity 1502 may also include means for transmitting an assistance data configuration for the UE, where at least one first area ID in the set of area IDs is associated with the assistance data configuration. The network entity 1502 may also include means for receiving, from the UE, an indication of a UE capability for an association of a plurality of area IDs with a plurality of positioning methods, where the plurality of area IDs corresponds to the set of area IDs, and where the plurality of positioning methods corresponds to the set of positioning measurements. The means may be the location component 198 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

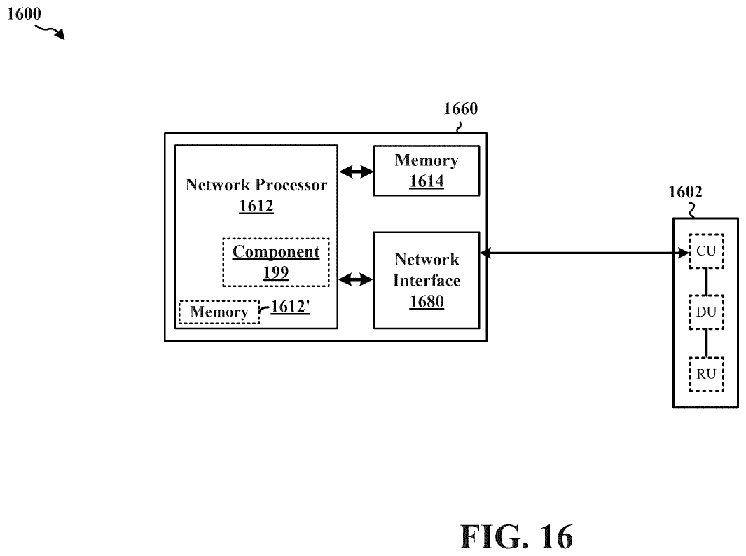

FIG. 16 is a diagram 1600 illustrating an example of a hardware implementation for a network entity 1660. In one example, the network entity 1660 may be within the core network 120. The network entity 1660 may include a network processor 1612. The network processor 1612 may include on-chip memory 1612′. In some aspects, the network entity 1660 may further include additional memory modules 1614. The network entity 1660 communicates via the network interface 1680 directly (e.g., backhaul link) or indirectly (e.g., through a RIC) with the CU 1602. The on-chip memory 1612′ and the additional memory modules 1614 may each be considered a computer-readable medium/memory. Each computer-readable medium/memory may be non-transitory. The processor 1612 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the location component 199 may be configured to configure a measurement and reporting configuration for a set of area identifiers (IDs) associated with one or more areas, where the measurement and reporting configuration includes information associated with a performance of a set of positioning measurements and a report of the set of positioning measurements. The location component 199 may also be configured to transmit, for a user equipment (UE), a request to perform the set of positioning measurements for the one or more areas, where the request includes the measurement and reporting configuration for the set of area IDs associated with the one or more areas. The location component 199 may also be configured to receive the report of the set of positioning measurements based on the UE being within one area of the one or more areas. The location component 199 may also be configured to transmit an assistance data configuration for the UE, where at least one first area ID in the set of area IDs is associated with the assistance data configuration. The location component 199 may also be configured to receive, from the UE, an indication of a UE capability for an association of a plurality of area IDs with a plurality of positioning methods, where the plurality of area IDs corresponds to the set of area IDs, and where the plurality of positioning methods corresponds to the set of positioning measurements.

The location component 199 may be within the processor 1612. The location component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1660 may include a variety of components configured for various functions. In one configuration, the network entity 1660 may include means for configuring a measurement and reporting configuration for a set of area identifiers (IDs) associated with one or more areas, where the measurement and reporting configuration includes information associated with a performance of a set of positioning measurements and a report of the set of positioning measurements. The network entity 1660 may also include means for transmitting, for a user equipment (UE), a request to perform the set of positioning measurements for the one or more areas, where the request includes the measurement and reporting configuration for the set of area IDs associated with the one or more areas. The network entity 1660 may also include means for receiving the report of the set of positioning measurements based on the UE being within one area of the one or more areas. The network entity 1660 may also include means for transmitting an assistance data configuration for the UE, where at least one first area ID in the set of area IDs is associated with the assistance data configuration. The network entity 1660 may also include means for receiving, from the UE, an indication of a UE capability for an association of a plurality of area IDs with a plurality of positioning methods, where the plurality of area IDs corresponds to the set of area IDs, and where the plurality of positioning methods corresponds to the set of positioning measurements. The means may be the location component 199 of the network entity 1660 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a user equipment (UE), including a memory and at least one processor coupled to the memory and, based at least in part on information stored in the memory, the at least one processor is configured to: obtain a request to perform a set of positioning measurements for one or more areas, where the request includes a measurement and reporting configuration for a set of area identifiers (IDs) associated with the one or more areas, where the measurement and reporting configuration includes information associated with a performance of the set of positioning measurements and a report of the set of positioning measurements; perform the set of positioning measurements based on the UE being within one area of the one or more areas associated with the set of area IDs; and transmit, for a network entity after the performance of the set of positioning measurements, the report of the set of positioning measurements based on the UE being within the one area of the one or more areas associated with the set of area IDs. Aspect 2 is the apparatus of aspect 1, where the at least one processor is further configured to: receive an assistance data configuration from the network entity, where at least one first area ID in the set of area IDs is associated with the assistance data configuration.

Aspect 3 is the apparatus of aspect 2, where the at least one first area ID in the set of area IDs associated with the assistance data configuration is identical to at least one second area ID in the set of area IDs associated with the measurement and reporting configuration.

Aspect 4 is the apparatus of aspect 2, where the at least one first area ID in the set of area IDs associated with the assistance data configuration is different from at least one second area ID in the set of area IDs associated with the measurement and reporting configuration.

Aspect 5 is the apparatus of any of aspects 1 to 4, where the measurement and reporting configuration includes at least one of a set of measurement parameters or a set of positioning measurement information elements (IEs), where at least one of the set of measurement parameters or the set of positioning measurement IEs is associated with the set of area IDs.

Aspect 6 is the apparatus of aspect 5, where at least one of the set of measurement parameters or the set of positioning measurement IEs is associated with downlink angle of departure (AoD) location information, and where the set of positioning measurement IEs includes at least one of: a downlink positioning reference signal (PRS) reference signal received power (RSRP) measurement per transmission-reception point (TRP) IE, a reference signal received power (RSRP) or path-RSRP measurement request IE, a line-of-sight (LOS) or non-LOS (NLOS) indicator request IE, or a requested downlink PRS processing sample IE.

Aspect 7 is the apparatus of any of aspects 5 to 6, where at least one of the set of measurement parameters or the set of positioning measurement IEs is associated with downlink time difference of arrival (TDOA) location information, and where the set of positioning measurement IEs includes at least one of: a requested measurement IE, an additional path IE, a reception (Rx) timing error group (TEG) request IE, a line-of-sight (LOS) or non-LOS (NLOS) indicator request IE, an additional path extension IE, an additional path downlink positioning reference signal (PRS) reference signal received power (RSRP) request IE, a downlink PRS reference signal time difference (RSTD) measurement per transmission-reception point (TRP) pair IE, a timing reporting granularity factor IE, a measure same downlink PRS resource with different reception (Rx) timing error group (TEG) IE, or a requested downlink PRS processing sample IE.

Aspect 8 is the apparatus of any of aspects 5 to 7, where at least one of the set of measurement parameters or the set of positioning measurement IEs is associated with an area ID-based positioning measurement, where the set of positioning measurement IEs includes at least one of: a line-of-sight (LOS) or non-LOS (NLOS) indicator request IE, an additional path reporting IE, a reference signal received power (RSRP) or path-RSRP reporting IE, an RSRP for additional paths IE, a number of samples for positioning reference signal (PRS) processing IE, a reception (Rx) timing error group (TEG) IE, or a number of RSRPs or path-RSRPs IE.

Aspect 9 is the apparatus of any of aspects 5 to 8, where at least one of the set of measurement parameters or the set of positioning measurement IEs is associated with multiple round trip time (multi-RTT) location information, and where the set of positioning measurement IEs includes at least one of: a requested measurement IE, an additional path IE, a reception (Rx)-transmission (Tx) timing error group (TEG) request IE, a measure same downlink positioning reference signal (PRS) resource with different Rx-Tx TEG IE, a measure same downlink PRS resource with different Rx TEG IE, a requested downlink PRS processing sample IE, a line-of-sight (LOS) or non-LOS (NLOS) indicator request IE, an additional path extension IE, an additional path downlink PRS reference signal received power (RSRP) request IE, a downlink PRS Rx-Tx time difference measurement per transmission-reception point (TRP) IE, or a timing reporting granularity factor IE.

Aspect 10 is the apparatus of any of aspects 1 to 9, where a second set of area IDs is associated with assistance data (AD) for the one or more areas, where the second set of area IDs include different transmission-reception points (TRPs) compared to the set of area IDs for the measurement and reporting configuration.

Aspect 11 is the apparatus of any of aspects 1 to 10, where each area ID in the set of area IDs is associated with a set of transmission-reception point (TRP) IDs for a set of TRPs within the one or more areas.

Aspect 12 is the apparatus of any of aspects 1 to 11, where the one area of the one or more areas corresponds to an area in which the UE is camped on a transmission-reception point (TRP) in a set of TRPs within the one or more areas.

Aspect 13 is the apparatus of any of aspects 1 to 12, where the at least one processor is further configured to: transmit, for the network entity, an indication of a UE capability for an association of a plurality of area IDs with a plurality of positioning methods, where the plurality of area IDs corresponds to the set of area IDs, and where the plurality of positioning methods corresponds to the set of positioning measurements.

Aspect 14 is the apparatus of any of aspects 1 to 13, where to obtain the request to perform the set of positioning measurements for the one or more areas, the at least one processor is configured to: receive, from the network entity, the request to perform the set of positioning measurements for the one or more areas.

Aspect 15 is the apparatus of any of aspects 1 to 14, further including at least one of a transceiver or an antenna coupled to the at least one processor, where to transmit the report of the set of positioning measurements, the at least one processor is configured to: transmit the report of the set of positioning measurements via at least one of the transceiver or the antenna.

Aspect 16 is an apparatus for wireless communication at a network entity, including a memory and at least one processor coupled to the memory and, based at least in part on information stored in the memory, the at least one processor is configured to: configure a measurement and reporting configuration for a set of area identifiers (IDs) associated with one or more areas, where the measurement and reporting configuration includes information associated with a performance of a set of positioning measurements and a report of the set of positioning measurements; transmit, for a user equipment (UE), a request to perform the set of positioning measurements for the one or more areas, where the request includes the measurement and reporting configuration for the set of area IDs associated with the one or more areas; and receive the report of the set of positioning measurements based on the UE being within one area of the one or more areas.

Aspect 17 is the apparatus of aspect 16, where the at least one processor is further configured to: transmit an assistance data configuration for the UE, where at least one first area ID in the set of area IDs is associated with the assistance data configuration.

Aspect 18 is the apparatus of aspect 17, where the at least one first area ID in the set of area IDs associated with the assistance data configuration is identical to at least one second area ID in the set of area IDs associated with the measurement and reporting configuration.

Aspect 19 is the apparatus of aspect 17, where the at least one first area ID in the set of area IDs associated with the assistance data configuration is different from at least one second area ID in the set of area IDs associated with the measurement and reporting configuration.

Aspect 20 is the apparatus of any of aspects 16 to 19, where the measurement and reporting configuration includes at least one of a set of measurement parameters or a set of positioning measurement information elements (IEs), where at least one of the set of measurement parameters or the set of positioning measurement IEs is associated with the set of area IDs.

Aspect 21 is the apparatus of aspect 20, where at least one of the set of measurement parameters or the set of positioning measurement IEs is associated with downlink angle of departure (AoD) location information, and where the set of positioning measurement IEs includes at least one of: a downlink positioning reference signal (PRS) reference signal received power (RSRP) measurement per transmission-reception point (TRP) IE, a reference signal received power (RSRP) or path-RSRP measurement request IE, a line-of-sight (LOS) or non-LOS (NLOS) indicator request IE, or a requested downlink PRS processing sample IE.

Aspect 22 is the apparatus of any of aspects 20 to 21, where at least one of the set of measurement parameters or the set of positioning measurement IEs is associated with downlink time difference of arrival (TDOA) location information, and where the set of positioning measurement IEs includes at least one of: a requested measurement IE, an additional path IE, a reception (Rx) timing error group (TEG) request IE, a line-of-sight (LOS) or non-LOS (NLOS) indicator request IE, an additional path extension IE, an additional path downlink positioning reference signal (PRS) reference signal received power (RSRP) request IE, a downlink PRS reference signal time difference (RSTD) measurement per transmission-reception point (TRP) pair IE, a timing reporting granularity factor IE, a measure same downlink PRS resource with different reception (Rx) timing error group (TEG) IE, or a requested downlink PRS processing sample IE.

Aspect 23 is the apparatus of any of aspects 20 to 22, where at least one of the set of measurement parameters or the set of positioning measurement IEs is associated with an area ID-based positioning measurement, where the set of positioning measurement IEs includes at least one of: a line-of-sight (LOS) or non-LOS (NLOS) indicator request IE, an additional path reporting IE, a reference signal received power (RSRP) or path-RSRP reporting IE, an RSRP for additional paths IE, a number of samples for positioning reference signal (PRS) processing IE, a reception (Rx) timing error group (TEG) IE, or a number of RSRPs or path-RSRPs IE.

Aspect 24 is the apparatus of any of aspects 20 to 23, where at least one of the set of measurement parameters or the set of positioning measurement IEs is associated with multiple round trip time (multi-RTT) location information, and where the set of positioning measurement IEs includes at least one of: a requested measurement IE, an additional path IE, a reception (Rx)-transmission (Tx) timing error group (TEG) request IE, a measure same downlink positioning reference signal (PRS) resource with different Rx-Tx TEG IE, a measure same downlink PRS resource with different Rx TEG IE, a requested downlink PRS processing sample IE, a line-of-sight (LOS) or non-LOS (NLOS) indicator request IE, an additional path extension IE, an additional path downlink PRS reference signal received power (RSRP) request IE, a downlink PRS Rx-Tx time difference measurement per transmission-reception point (TRP) IE, or a timing reporting granularity factor IE.

Aspect 25 is the apparatus of any of aspects 16 to 24, where a second set of area IDs is associated with assistance data (AD) for the one or more areas, where the second set of area IDs include different transmission-reception points (TRPs) compared to the set of area IDs for the measurement and reporting configuration.

Aspect 26 is the apparatus of any of aspects 16 to 25, where each area ID in the set of area IDs is associated with a set of transmission-reception point (TRP) IDs for a set of TRPs within the one or more areas.

Aspect 27 is the apparatus of any of aspects 16 to 26, further including at least one of a transceiver or an antenna coupled to the at least one processor, where to receive the report of the set of positioning measurements, the at least one processor is configured to: receive the report of the set of positioning measurements via at least one of the transceiver or the antenna, and where the one area of the one or more areas corresponds to an area in which the UE is camped on a transmission-reception point (TRP) in a set of TRPs within the one or more areas.

Aspect 28 is the apparatus of any of aspects 16 to 27, where the at least one processor is further configured to: receive, from the UE, an indication of a UE capability for an association of a plurality of area IDs with a plurality of positioning methods, where the plurality of area IDs corresponds to the set of area IDs, and where the plurality of positioning methods corresponds to the set of positioning measurements.

Aspect 29 is the apparatus of any of aspects 1 to 28, where the apparatus is a wireless communication device, further including at least one of an antenna or a transceiver coupled to the at least one processor.

Aspect 30 is a method of wireless communication for implementing any of aspects 1 to 28.

Aspect 31 is an apparatus for wireless communication including means for implementing any of aspects 1 to 28.

Aspect 32 is a computer-readable medium (e.g., a non-transitory computer-readable medium) storing computer executable code, the code when executed by at least one processor causes the at least one processor to implement any of aspects 1 to 28.

1. An apparatus for wireless communication at a user equipment (UE), comprising: a memory; and
at least one processor coupled to the memory and, based at least in part on first information stored in the memory, the at least one processor is configured to:
obtain a request to perform a set of positioning measurements for one or more areas, wherein the request includes a measurement and reporting configuration for a set of area identifiers (IDs) associated with the one or more areas, wherein the measurement and reporting configuration includes information associated with a performance of the set of positioning measurements and a report of the set of positioning measurements;
perform the set of positioning measurements based on the UE being within one area of the one or more areas associated with the set of area IDs; and transmit, for a network entity after the performance of the set of positioning measurements, the report of the set of positioning measurements based on the UE being within the one area of the one or more areas associated with the set of area IDs.

2. The apparatus of claim 1, wherein the at least one processor is further configured to:
receive an assistance data configuration from the network entity, wherein at least one first area ID in the set of area IDs is associated with the assistance data configuration.

3.-4. (canceled)

5. The apparatus of claim 1, wherein the measurement and reporting configuration includes at least one of a set of measurement parameters or a set of positioning measurement information elements (IES), wherein at least one of the set of measurement parameters or the set of positioning measurement IEs is associated with the set of area IDs.

6. The apparatus of claim 5, wherein at least one of the set of measurement parameters or the set of positioning measurement IEs is associated with downlink angle of departure (AoD) location information, and wherein the set of positioning measurement IEs includes at least one of: a downlink positioning reference signal (PRS) reference signal received power (RSRP) measurement per transmission-reception point (TRP) IE, a reference signal received power (RSRP) or path-RSRP measurement request IE, a line-of-sight (LOS) or non-LOS (NLOS) indicator request IE, or a requested downlink PRS processing sample IE.

7. The apparatus of claim 5, wherein at least one of the set of measurement parameters or the set of positioning measurement IEs is associated with downlink time difference of arrival (TDOA) location information, and wherein the set of positioning measurement IEs includes at least one of: a requested measurement IE, an additional path IE, a reception (Rx) timing error group (TEG) request IE, a line-of-sight (LOS) or non-LOS (NLOS) indicator request IE, an additional path extension IE, an additional path downlink positioning reference signal (PRS) reference signal received power (RSRP) request IE, a downlink PRS reference signal time difference (RSTD) measurement per transmission reception point (TRP) pair IE, a timing reporting granularity factor IE, a measure same downlink PRS resource with different reception (Rx) timing error group (TEG) IE, or a requested downlink PRS processing sample IE.

8. The apparatus of claim 5, wherein at least one of the set of measurement parameters or the set of positioning measurement IEs is associated with an area ID-based positioning measurement, wherein the set of positioning measurement IEs includes at least one of: a line-of-sight (LOS) or non-LOS (NLOS) indicator request IE, an additional path reporting IE, a reference signal received power (RSRP) or path-RSRP reporting IE, an RSRP for additional paths IE, a number of samples for positioning reference signal (PRS) processing IE, a reception (Rx) timing error group (TEG) IE, or a number of RSRPs or path-RSRPs IE.

9. The apparatus of claim 5, wherein at least one of the set of measurement parameters or the set of positioning measurement IES is associated with multiple round trip time (multi-RTT) location information, and wherein the set of positioning measurement IEs includes at least one of: a requested measurement IE, an additional path IE, a reception (Retransmission (Tx) timing error group (TEG) request IE, a measure same downlink positioning reference signal (PRS) resource with different Rx-Tx TEG IE, a measure same downlink PRS resource with different Rx TEG IE, a requested downlink PRS processing sample IE, a line-of-sight (LOS) or non-LOS (NLOS) indicator request IE, an additional path extension IE, an additional path downlink PRS reference signal received power (RSRP) request IE, a downlink PRS Rx-Tx time difference measurement per transmission-reception point (TRP) IE, or a timing reporting granularity factor IE.

10. The apparatus of claim 1, wherein a second set of area IDs is associated with assistance data (AD) for the one or more areas, wherein the second set of area IDs include different transmission-reception points (TRPs) compared to the set of area IDs for the measurement and reporting configuration.

11. The apparatus of claim 1, wherein each area ID in the set of area IDs is associated with a set of transmission-reception point (TRP) IDs for a set of TRPs within the one or more areas.

12. The apparatus of claim 1, wherein the one area of the one or more areas corresponds to an area in which the UE is camped on a transmission-reception point (TRP) in a set of TRPs within the one or more areas.

13. The apparatus of claim 1, wherein the at least one processor is further configured to:
transmit, for the network entity, an indication of a UE capability for an association of a plurality of area IDs with a plurality of positioning methods, wherein the plurality of area IDs corresponds to the set of area IDs, and wherein the plurality of positioning methods corresponds to the set of positioning measurements.

14. The apparatus of claim 1, wherein to obtain the request to perform the set of positioning measurements for the one or more areas, the at least one processor is configured to: receive, from the network entity, the request to perform the set of positioning measurements for the one or more areas.

15. The apparatus of claim 1, further comprising at least one of a transceiver or an antenna coupled to the at least one processor, wherein to transmit the report of the set of positioning measurements, the at least one processor is configured to:
transmit the report of the set of positioning measurements via at least one of the transceiver or the antenna.

16. An apparatus for wireless communication at a network entity, comprising:
a memory; and
at least one processor coupled to the memory and, based at least in part on first information stored in the memory, the at least one processor is configured to:
configure a measurement and reporting configuration for a set of area identifiers (IDs) associated with one or more areas, wherein the measurement and reporting configuration includes information associated with a performance of a set of positioning measurements and a report of the set of positioning measurements;
transmit, for a user equipment (UE), a request to perform the set of positioning measurements for the one or more areas, wherein the request includes the measurement and reporting configuration for the set of area IDs associated with the one or more areas; and
receive the report of the set of positioning measurements based on the UE being within one area of the one or more areas.

17. The apparatus of claim 16, wherein the at least one processor is further configured to:
transmit an assistance data configuration for the UE, wherein at least one first area ID in the set of area IDs is associated with the assistance data configuration.

18.-19. (canceled)

20. The apparatus of claim 16, wherein the measurement and reporting configuration includes at least one of a set of measurement parameters or a set of positioning measurement information elements (IES), wherein at least one of the set of measurement parameters or the set of positioning measurement IEs is associated with the set of area IDs.

21. The apparatus of claim 20, wherein at least one of the set of measurement parameters or the set of positioning measurement IEs is associated with downlink angle of departure (AoD) location information, and wherein the set of positioning measurement IEs includes at least one of: a downlink positioning reference signal (PRS) reference signal received power (RSRP) measurement per transmission-reception point (TRP) IE, a reference signal received power (RSRP) or path-RSRP measurement request IE, a line-of-sight (LOS) or non-LOS (NLOS) indicator request IE, or a requested downlink PRS processing sample IE.

22.-26. (canceled)

27. The apparatus of claim 16, further comprising at least one of a transceiver or an antenna coupled to the at least one processor, wherein to receive the report of the set of positioning measurements, the at least one processor is configured to:
receive the report of the set of positioning measurements via at least one of the transceiver or the antenna, and wherein the one area of the one or more areas corresponds to an area in which the UE is camped on a transmission-reception point (TRP) in a set of TRPs within the one or more areas.

28. The apparatus of claim 16, wherein the at least one processor is further configured to:
receive, from the UE, an indication of a UE capability for an association of a plurality of area IDs with a plurality of positioning methods, wherein the plurality of area IDs corresponds to the set of area IDs, and wherein the plurality of positioning methods corresponds to the set of positioning measurements.

29. A method of wireless communication at a user equipment (UE), comprising:
obtaining a request to perform a set of positioning measurements for one or more areas, wherein the request includes a measurement and reporting configuration for a set of area identifiers (IDs) associated with the one or more areas, wherein the measurement and reporting configuration includes information associated with a performance of the set of positioning measurements and a report of the set of positioning measurements;
performing the set of positioning measurements based on the UE being within one area of the one or more areas associated with the set of area IDs; and
transmitting, for a network entity after the performance of the set of positioning measurements, the report of the set of positioning measurements based on the UE being within the one area of the one or more areas associated with the set of area IDs.

30. (canceled)
